(19) United States
(12) Patent Application Publication
(10) Pub. No.: US 2012/0074071 A1
(43) Pub. Date: Mar. 29, 2012

(54) PROCESS FOR TREATING WATERS AND WATER HANDLING SYSTEMS TO REMOVE SCALES AND REDUCE THE SCALING TENDENCY

(75) Inventors: Carl Hassler, Gig Harbor, WA (US); John Burba, Parker, CO (US); Robert Cable, Las Vegas, NV (US)

(73) Assignee: MOLYCORP MINERALS, LLC, Greenwood Village, CO (US)

(21) Appl. No.: 13/244,092

(22) Filed: Sep. 23, 2011

Related U.S. Application Data
(60) Provisional application No. 61/385,880, filed on Sep. 23, 2010.
(60) Provisional application No. 61/386,407, filed on Sep. 24, 2010.
(60) Provisional application No. 61/392,804, filed on Oct. 13, 2010.
(60) Provisional application No. 61/412,272, filed on Nov. 10, 2010.
(60) Provisional application No. 61/419,630, filed on Dec. 3, 2010.

(51) Int. Cl. C02F 5/08

(52) U.S. Cl. 210/763; 210/749; 210/209

(57) ABSTRACT

The present disclosure includes an embodiment to a method for treating water and/or a water handling system to decrease deposit formation and/or to remove a deposit. More particularly, to a method for treating water and/or a water handling system with one or more rare earths to decrease deposit formation and/or to remove a deposit. Struvite is an example of deposit material that can be removed and/or deposition inhibited by treating a water and/or water handling system with one or more earths.

### CROSS REFERENCE TO RELATED APPLICATIONS

The present application claims the benefits of U.S. Provisional Application Ser. Nos. 61/385,880 with a filing date of Sep. 23, 2010, 61/386,407 with a filing date of Sep. 24, 2010, 61/392,804 with a filing date of Oct. 13, 2010, 61/412,272 with a filing date of Nov. 10, 2010, 61/419,630 with a filing date of Dec. 3, 2010, all entitled “Process for Treating Waters and Water Handling Systems Using Rare Earth Metals”, each of which is incorporated in its entirety herein by this reference.

Cross reference is made to U.S. patent application Ser. No. ______, filed Sep. 23, 2011, entitled “PARTICULATE CERIUM DIOXIDE AND AN IN SITU METHOD FOR MAKING AND USING THE SAME” having attorney docket no. 6062-89-4, which is incorporated herein by this reference in its entirety.

### FIELD OF INVENTION

The present disclosure comprises a method for treating water and/or a water handling system to decrease deposition and/or scaling tendency, more particularly to a method for treating water and/or a water handling system with one or more rare earths to decrease deposition and/or scaling tendency of the water and/or water handling system.

### BACKGROUND OF THE INVENTION

Aqueous systems are susceptible to accumulation of unwanted deposits and/or scales. Accumulation of unwanted deposits adversely affects water quality and performance of a water handling system. For example, accumulation of a deposit may impede and/or interfere with the functional operation of the water handling system. The deposit may occur on piping, within a flow channel, or on a component (such as heat exchanger, filtering, heating, injection, spraying, and/or transfer surfaces). The accumulation of the deposit on the component may reduce one or more of thermal efficiency, decrease heat flux, increase heat retention, decrease cooling efficiency, induce and/or accelerate corrosion, reduce fluid flow, increase pressure and/or pressure drops, cause flow oscillations and/or slugging, cause fluid flow blockages, and induce cavitation.

Furthermore, accumulation of the deposit can affect water quality, such as water clarity, odor, color, safety, toxicity, contaminant level and/or ability to be processed by the water handling system. Moreover, the deposit may render the water unsuitable for its intended use.

Struvite, NH₄MgPO₄, is a non-limiting example of a problematic deposit material typically encountered in water handling systems. Struvite is a soft mineral that is soluble in acidic aqueous solutions and only very slightly soluble in neutral and alkaline aqueous solutions. Moreover, struvite readily precipitates in industrial and municipal water treatment facilities having high forms of concentrated ammonium, magnesium and phosphate. Struvite scales can block and/or destroy pipes, pumps and values systems. As such, struvite is an undesirable by-product in many processes. While struvite scale typically can be removed with an acidic solution (of pH 5 or less), the resulting solution can have a high phosphate content and a low pH, therefore, the resulting solution requires a phosphate fixative and neutralization. Other methods for preventing struvite deposition include the use of ethylenediaminetretraacetic acid, ferric chloride, alum and/or polymeric materials.

A need exists for a method for treating water and/or a water handling system to decrease deposit formation.

### SUMMARY OF THE INVENTION

These and other needs are addressed by the various embodiments and configurations of this disclosure. This disclosure relates generally to a method for treating water and/or a water handling system to decrease deposition and/or scaling tendency of the water and/or water handling system. More particularly, this disclosure is to a method for treating water and/or a water handling system with one or more rare earths to decrease deposition and/or scaling tendency of the water and/or water handling system.

Some embodiments are to a process. The process includes contacting a rare earth-containing additive with a deposit material contained within a water handling system to one or both of remove the deposit material and inhibit deposition of the deposit material. The contacting of the rare earth-containing additive preferably occurs in a water handling system. Furthermore, the contacting of the rare earth-containing additive with the deposit material forms a deposit-laden rare earth composition. Preferably, the process further includes removing the deposit laden rare earth composition from the water handling system.

Some embodiments include contacting, within a water handling system, a rare earth-containing additive with a deposit material to form a deposit-laden rare composition and to one or both of remove the deposit from the water handling system and inhibit the formation of more deposit material within the water handling system. Preferably, some embodiments further include removing a deposit laden rare earth composition from the water handling system.

Preferably, the deposit material is adhered to a component of the water handling system and/or is in the form of deposit particulates suspended in water. More preferably, the deposit material is struvite. At least some of the struvite is removed from the water handling system by the rare earth-containing additive, preferably by the contacting of the rare earth-containing additive with deposit material.

Regarding the deposit material particulates, the deposit particulates have an average particle size. The contacting of the rare earth-containing additive with the deposit material substantially preferably inhibits an increase in the average particle size. More preferably, the contacting of the rare earth-containing additive with the deposit material removes at least some of the deposit particulates from the water handling system.

Regarding the deposit material adhered to a component of the water handling system, the contacting of the rare earth-containing additive with the deposit material preferably removes at least some of the deposit material adhered to the component of the water handling system.

Regarding the deposit-laden rare earth composition, preferably the deposit-laden rare earth composition contains phosphate. The deposit-laden rare earth composition is substantially insoluble in water.

Some embodiments include contacting a water handling system containing struvite with a rare earth-containing additive to form a rare earth composition comprising a component of the struvite and to one or both of remove the struvite from the water handling system and inhibit the formation of more struvite within the water handling system. Preferably, the struvite is adhered to a component of the water handling system and/or is in the form of particulates suspended in the water. The struvite particulates have an average particle size. The contacting of the rare earth-containing additive with a component of the struvite substantially preferably inhibits an increase in the average particle size, more preferably removes at least some of the struvite particulates from the water handling system. Regarding the struvite adhered to a component of the water handling system, the contacting of the rare earth-containing additive with a component of the struvite removes at least some of the struvite adhered to the component of the water handling system. The rare earth composition containing the component of struvite is substantially insoluble in water. Preferably, the further includes removing the rare earth composition containing the component of struvite from the water handling system.

Some embodiments include a system. The system includes a deposit-laden water handling system containing a deposit material adhered to a component of the water handling system; an input to receive a rare earth-containing additive and an output to output the deposit-laden rare earth composition and to form a deposit-free water handling system substantially lacking deposit material adhered to the water handling system. Preferably, the rare earth-containing additive is contacted with the deposit material to form a deposit-laden rare earth composition and to substantially remove the deposit material adhered to the component of the water handling system.

In some embodiments, the rare earth-containing additive includes a water-soluble rare earth-containing composition. The rare earth-containing and/or water-soluble rare earth-containing compositions preferably include one of a rare earth having a +3 oxidation state, a +4 oxidation or mixture of +3 and +4 oxidation states. Preferably, rare earth-containing and/or water-soluble rare earth-containing compositions preferably include cerium.

The term “water” refers to any aqueous composition. The water may originate from any natural and/or industrial source. Non-limiting examples of such waters are drinking waters, potable waters, recreational waters, waters derived from manufacturing processes, wastewaters, pool waters, spa waters, cooling waters, boiler waters, process waters, municipal waters, sewage waters, agricultural waters, ground waters, power plant waters, remediation waters, co-mingled water and combinations thereof.

The term “water handling system” refers to any system containing, conveying, manipulating, physically transforming, chemically processing, mechanically processing, purifying, generating and/or forming the aqueous composition, treating, mixing and/or co-mingling the aqueous composition with one or more other waters and any combination thereof.

The terms “water” and “water handling system” will be used interchangeably. That is, the term “water” may used to refer to “a water handling system” and the term “water handling system” may be used to refer to the term “water”.

A “deposit” and/or “deposit material” refer to a material associated with a water handling system (such as a scale adhered to one or components of the water handling system) and/or contained in water (such as a suspended or dissolved material). The terms “scale” and “deposit” will be used herein interchangeably. Struvite is a non-limiting example of a deposit material. Furthermore, with regards to the non-limiting example of struvite, the terms deposit and deposit material refers to one or more of a scale adhered to a component of the water handling system (such as, a struvite (NH₄MgPO₄) scale), particulates suspended in the water (such as, suspended struvite particulates), and the deposit material in a dissolved state within water (such as, struvite in the dissolved state in the form of dissociated, dissolved ammonium (NH₄⁺), magnesium (Mg²⁺) and phosphate (PO₄³⁻) ions). Furthermore, the deposit material may be an inorganic material, mineral, organic material, biological matter or combination thereof. The deposit materials comprising biological matter include, without limitation, bacteria, algae, funguses, molds, viruses, and other microbes. Non-limiting examples of inorganic, organic and mineral deposit materials typically comprise arsenates, arsenates, sulfates, carbonates, oxalates, silicates, phosphates, barium hydrogen phosphate (BaHPO₄), barium pyrophosphate (Ba₂P₂O₇), bismuth phosphate (BiPO₄), cadmium phosphate (Cd₃(PO₄)₂), mono-calcium phosphate (Ca(H₂PO₄)₂), di-calcium phosphate (CaHPO₄), calcium phosphate (Ca₃(PO₄)₂), lead hydrogen phosphate (PbHPO₄), lithium phosphate (Li₃PO₄), magnesium phosphate (Mg₃(PO₄)₂), nickel phosphate (Ni₂P₂O₇), thallium phosphate (Tl₃PO₄), barium arsenate (Ba₃(ASO₄)₂), bismuth arsenate (BiAsO₄), cadmium arsenate (Cd₃(AsO₄)₂), calcium arsenate (Ca₃(AsO₄)₂), ferric arsenate (FeAsO₄), struvite (NH₄MgPO₄) and combinations thereof.

A “water handling system component” refers to one or more unit operations and/or pieces of equipment that process and/or treat water (such as a holding tank, reactor, purifier, treatment vessel or unit, mixing vessel or element, wash circuit, precipitation vessel, separation vessel or unit, settling tank or vessel, reservoir, pump, aerator, cooling tower, heat exchanger, value, boiler, filtration device, solid liquid and/or gas liquid separator, nozzle, tender, and such), conduits interconnecting the unit operations and/or equipment (such as piping, hoses, channels, aqua-ducts, ditches, and such) and the water conveyed by the conduits.

The term “scaling tendency” refers to the characteristic and/or potential of a water to form a deposit, typically to form a scale and/or particulates suspended in the water. The greater the scaling tendency the more likely a deposit may form.

The terms “alkaline earth” and/or “Group 2” metals refer to one or more of beryllium (Be), magnesium (Mg), calcium (Ca), strontium (Sr), barium (Ba), and radium (Ra).

The terms “pnictogen” and/or “Group 15” refers to one or more of nitrogen (N), phosphorous (P), arsenic (As), antimony (Sb) and bismuth (Bi).

A “halogen” is a nonmetal element from Group 17 IUPAC Style (formerly: VII, VIIA) of the periodic table, comprising fluorine (F), chlorine (Cl), bromine (Br), iodine (I), and astatine (At). The artificially created element 117, provisionally referred to by the systematic name ununseptium, may also be a halogen. A “halide compound” is a compound having as one part of the compound at least one halogen atom and the other part the compound is an element or radical that is less electronegative (or more electropositive) than the halogen. The halide compound is typically a fluoride, chloride, bromide, iodide, or astatide compound. Many salts are halides having a halide anion. A halide anion is a halogen atom bearing a negative charge. The halide anions are fluoride (F⁻), chloride (Cl⁻), bromide (Br⁻), iodide (I⁻) and astatide (At⁻).

“Absorption” refers to the penetration of one substance into the inner structure of another, as distinguished from adsorption.

“Adsorption” refers to the adherence of atoms, ions, molecules, polyatomic ions, or other substances of a gas or liquid to the surface of another substance, called the adsorbent. Typically, the attractive force for adsorption can be ionic forces such as covalent, or electrostatic forces, such as van der Waals and/or London's forces.

The term “sorb” refers to adsorption, absorption or both adsorption and absorption.

The term “composition” refers to one or more chemical units composed of one or more atoms, such as a molecule, polyatomic ion, chemical compound, coordination complex, coordination compound, and the like. As will be appreciated, a composition can be held together by various types of bonds and/or forces, such as covalent bonds, metallic bonds, coordination bonds, ionic bonds, hydrogen bonds, electrostatic forces (e.g., van der Waal's forces and London's forces), and the like.

The term “suspension” refers to a heterogeneous mixture of a solid, typically in the form of a particulate, dispersed in a liquid (the continuous phase). In a suspension, solid particulates are dispersed in a continuous liquid phase. The term “colloid” refers to a suspension comprising solid particulates that typically do not settle-out from the continuous liquid phase due to gravitational forces. As used hereinafter, the terms “suspension”, “colloid” or “slurry” will be used interchangeably to refer to one or more materials dispersed and/or suspended in a continuous liquid phase.

The terms “agglomerate” and “aggregate” refer to a composition formed by gathering one or more materials into a mass.

A “binder” refers to one or more substances that bind together a material being agglomerated. Binders are typically solids, semi-solids, or liquids. Non-limiting examples of binders are polymeric materials, tar, pitch, asphalt, wax, cement water, solutions, dispersions, powders, silicates, gels, oils, alcohols, clays, starch, silicates, acids, molasses, lime and lignosulphonate oils, hydrocarbons, glycerin, stearate, polymers, wax, or combinations thereof. The binder may or may not chemically react with the material being agglomerated. Non-liming examples of chemical reactions include hydration/dehydration, metal ion reactions, precipitation/gelation reactions, and surface charge modification.

The term “insoluble” refers to materials that are intended to be and/or remain as solids in water and are able to be retained in a device, such as a column, or be readily recovered from a batch reaction using physical means, such as filtration. Insoluble materials should be capable of prolonged exposure to water, over weeks or months, with little loss of mass. Typically, a little loss of mass refers to less than about 5% mass loss of the insoluble material after a prolonged exposure to water.

The term “oxidizing agent” refers to one or both of a chemical substance and physical process that transfers and/or assists in removal of one or more electrons from a substance. The substance having the one or more electrons being removed is oxidized. In regards to the physical process, the physical process may removal and/or may assist in the removal of one or more electrons from the substance being oxidized. For example, the substance to be oxidized can be oxidized by electromagnetic energy when the interaction of the electromagnetic energy with the substance be oxidized is sufficient to substantially remove one or more electrons from the substance. On the other hand, the interaction of the electromagnetic energy with the substance being oxidized may not be sufficient to remove one or more electrons, but may be enough to excite electrons to higher energy state, were the electron in the excited state can be more easily removed by one or more of a chemical substance, thermal energy, or such.

The terms “oxyanion” and/or “oxoanion” are chemical compounds with the generic formula AₓO_{y}^{z-} (where A represents a chemical element other than oxygen, O represents the element oxygen and x, y and z represent real numbers). In the embodiments having oxyanions as a chemical contaminant, “A” represents metal, metalloid, and/or non-metal elements. Examples for metal-based oxyanions include chromate, tungstate, molybdate, aluminates, zirconate, etc. Examples of metalloid-based oxyanions include arsenate, arsenite, antimonate, germanate, silicate, etc. Examples of non-metal-based oxyanions include phosphate, selemate, sulfate, etc.

The term “phosphate” refers to phosphorous-containing oxyanions typically formed from a PO₄ (phosphate) structural unit alone or linked together by sharing oxygen atoms to form a linear chain or cyclic ring structure. Non-limiting examples of phosphates are: PO₄³⁻ (phosphate); P₃O₁₀⁵⁻ (triphosphate); PₙO₃ₙ⁽ⁿ⁺²⁾⁻ (polyphosphate); P₃O₉³⁻ (cyclic trimethaphosphate); adenosine diphosphoric acid (ADPH); guanosine 5′-diphosphate 3′-dipphosphate (ppGpp); trimetaphosphate; hexametaphosphate; HPO₃²⁻ (phosphate); H₂P₂O₅²⁻ (pyrophosphites); H₂PO₂⁻ (hypophosphite); one or more of their salts, acids, esters, anionic and organophosphorus forms; and mixtures thereof.

“Precipitation” refers not only to the removal of a deposit material in the form of insoluble species but also to the immobilization of the deposit material on or in the rare earth-containing agglomerate, the rare earth composition, rare earth-containing particle and/or rare earth-containing additive and/or the rare earth comprising the rare earth composition, additive and/or particle. For example, “precipitation” includes processes, such as adsorption and absorption of the deposit material by the rare earth-containing agglomerate, the rare earth composition, rare earth-containing particle, rare earth-containing additive and/or the rare earth comprising the rare earth composition, additive and/or particle.

“Rare earth” refers to one or more of yttrium, scandium, lanthanum, cerium, praseodymium, neodymium, samarium, europium, gadolinium, terbium, dysprosium, holmium erbium, thulium, ytterbium, and lutetium. As will be appreciated, lanthanum, cerium, praseodymium, neodymium, samarium, europium, gadolinium, terbium, dysprosium, holmium erbium, thulium, ytterbium, and lutetium are known as lanthanoids.

The terms “rare earth-containing composition”, “rare earth-containing additive” and “rare earth-containing particle” refer to any composition containing a rare earth other than non-compositionally altered rare earth-containing minerals. In other words, as used herein “rare earth-containing composition”, “rare earth-containing additive” and “rare earth-containing particle” exclude comminuted naturally occurring rare earth-containing minerals. However, as used herein “rare earth-containing composition”, “rare earth-containing additive” and “rare earth-containing particles” include a rare earth-containing mineral where one or both of the chemical composition and chemical structure of the rare earth-containing portion of the mineral has been compositionally altered. More specifically, a comminuted naturally occurring bastnasite would not be considered a rare earth-containing composition and/or rare earth-containing additive. However, a synthetically prepared bastnasite or a rare earth-containing composition prepared by a chemical transformation of naturally occurring bastnäsite would be considered a rare earth-containing composition and/or rare earth-containing additive. The rare earth and/or rare-containing composition and/or additive are, in one application, not a naturally occurring mineral but synthetically manufactured. Exemplary naturally occurring rare earth-containing minerals include bastnasite (a carbonate-fluoride mineral) and monazite. Other naturally occurring rare earth-containing minerals include aeschynite, allanite, apatite, britholite, brockite, cerite, fluorcerite, fluorite, gadolinite, parisite, stillwellite, synchisite, titanite, xenotime, zircon, and zirconolite. Exemplary uranium minerals include uraninite (UO₂), pitchblende (a mixed oxide, usually U₃O₈), brannerite (a complex oxide of uranium, rare-earths, iron and titanium), coffinite (uranium silicate), carnotite, autunite, davidite, gummite, torbernite and uranophane. In one formulation, the rare earth-containing composition is substantially free of one or more elements in Group 1, 2, 4-15, or 17 of the Periodic Table, a radioactive species, such as uranium, sulfur, selenium, tellurium, and polonium.

“Rare earth” and “rare earth-containing composition” refer both to singular and plural forms of the terms. More specifically, the term “rare earth” refers to a single rare earth and/or combination and/or mixture of rare earths and the term “rare earth-containing composition” refers to a single composition comprising a single rare earth and/or a mixture of differing rare earth-containing compositions containing one or more rare earths and/or a single composition containing one or more rare earths.

“Chemical transformation” refers to process where at least some of a material has had its chemical composition transformed by a chemical reaction. “A chemical transformation” differs from “a physical transformation”. A physical transformation refers to a process where the chemical composition has not been chemically transformed but a physical property, such as physical size or shape, has been transformed.

The term “soluble” refers to a material that readily dissolves in a fluid, such as water or other solvent. For purposes of this disclosure, it is anticipated that the dissolution of a soluble material would necessarily occur on a time scale of minutes rather than days. For the material to be considered to be soluble, it is necessary that the material/composition has a significantly high solubility in the fluid such that upwards of 5 g/L of the material will dissolve in and be stable in the fluid.

The terminology “removal”, “remove” or “removing” includes the sorption, precipitation, conversion and combination thereof a deposit material contained in a water and/or water handling system.

The term “fluid” refers to a liquid, gas or both.

The term “surface area” refers to surface area of a material and/or substance determined by any suitable surface area measurement method. Preferably, the surface area is determined by any suitable Brunauer-Emmett-Teller (BET) analysis technique for determining the specific area of a material and/or substance.

The terms “pore volume” and “pore size”, respectively, refer to pore volume and pore size determinations made by any suite measure method. Preferably, the pore size and pore volume are determined by any suitable Barret-Joyner-Halenda method for determining pore size and volume. Furthermore, it can be appreciated that as used herein pore size and pore diameter can used interchangeably.

The term “contained within the water” refers to materials suspended and/or dissolved within the water. Suspended materials are substantially insoluble in water and dissolved materials are substantially soluble in water. Water is typically a solvent for the dissolved materials. Furthermore, water is typically not a solvent for the insoluble materials. The suspended materials have a particle size.

As used herein, the term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

As used herein, “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The preceding is a simplified summary of the disclosure to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below.

### BRIEF DESCRIPTION OF THE DRAWINGS

The accompanying drawing, which is incorporated in and constitute a part of the specification, illustrates embodiments of the disclosure and together with the general description of the disclosure given above and the detailed description given below, serve to explain the principles of the disclosure.

FIG. 1 depicts a process according to an embodiment;

FIG. 2 is a series of XRD patterns exhibiting the structural differences between gasparite (CeAsO₄) and the novel trigonal phase CeAsO₄.(H₂O)_{X};

FIG. 3 is a series of XRD patterns exhibiting the structural differences among trigonal CeAsO₄.(H₂O)_{X} (experimental), trigonal CeAsO₄.(H₂O)_{X} (simulated), and trigonal BiPO₄.(H₂O)_{0.67} (simulated); and

FIG. 4 depicts various X-ray diffraction patterns as described in more detail in Detailed Description section.

### DETAILED DESCRIPTION OF THE INVENTION

### General Overview

The present disclosure is related to the use of water-soluble and insoluble rare earths and rare earth-containing additives to remove and/or inhibit deposition of a deposit material from water and/or a water handling system. That is, to reduce the scaling tendency of the water. The deposit material is typically one or more of a scale adhered to one or more components within the water handling system, particulates suspended in the water and a dissolved form of the deposit material. The dissolved form of the deposit material may comprise dissociated, dissolved ionic components comprising the deposit material. The dissolved ionic components of the deposit material typically comprise one or more anionic components and one or more cationic components. Preferably, at least one of the one or more anionic components comprise an oxyanion.

In one configuration, the deposit material is struvite. The struvite may be in the form of struvite scale adhered to one or more components of the water handling system, struvite particulates suspended in water, and/or struvite dissolved in water. The dissolved struvite comprises ammonium cations (NH₄⁺), magnesium cations (Mg²⁺) and phosphate anions (PO₄³⁻). The struvite scale and/or particulates comprise substantially insoluble NH₄MgSO₄. The molar ratios of ammonium, magnesium and phosphate, respectively, may or may not be in a 1:1:1 molar ratio.

### Deposit Materials

The deposit material can comprise one or more of fluoride, arsenite, arsenate, antimonite, bismuthate, pnictogon (Group 15) oxyanions, silicate, sulfate, phosphate, beryllium, calcium, barium, strontium, and magnesium. The deposit material can be in the form of a scale adhered to one or more components of the water handling system, a solid suspended in the water continuous phase, ions in a substantially dissociated, dissolved state, or a combination thereof. The form of the deposit material can vary depending on the temperature, pressure, pH value, gaseous content and flow properties of the water. Similarly, the form of deposit material can vary depending on water processing conditions, such as, but not limited to, temperature, rate of temperature change, evaporation rate, pressure variation (including pressure rate of pressure increase or decrease), degree of commingling of waters having differing constituents, flow rate, change in water constituents due treatment rendered to the water or any combination thereof.

Non-limiting examples of deposit materials are arsenates (such as, H₂AsO₄¹⁻, HAsO₄²⁻, AsO₄³⁻), arsenites (such as, H₂AsO₃¹⁻, HAsO₃²⁻ and AsO₃³⁻), sulfates (such as, HSO₄⁻ and/or SO₄²⁻), carbonates (such as, HCO₃¹⁻ and/or CO₃²⁻), oxalates (such as, H(COO)₂¹⁻ and/or (COO)₂²⁻), silicates (such as, H₃SiO₄¹⁻, H₂SiO₄²⁻, HSiO₄³⁻, SiO₄⁴⁻Si₂O₇⁶⁻, SiₙO₃ₙ²ⁿ⁻, Si₄nO₁₁ₙ⁶ⁿ⁻, and Si₂ₙO₅ₙ²ⁿ⁻ anions, where n is a positive real number), and phosphates (such as H₂PO₄¹⁻, HPO₄²⁻ and PO₄³⁻). Arsenate deposit materials can comprise the H₂AsO₄¹⁻, HAsO₄²⁻, AsO₄³⁻ anions in the solution phase and/or associated with at least one of barium, bismuth, cadmium, calcium, iron, cobalt, copper, silver, strontium, zinc, lead, mercury, nickel, beryllium, thallium, magnesium, aluminum and manganese. Arsenite deposit material can comprise H₂AsO₃¹⁻, HAsO₃²⁻ and AsO₃³⁻ anions in the solution phase and/or associate with at least one of barium, bismuth, cadmium, calcium, iron, cobalt, copper, silver, strontium, lead, mercury, nickel, beryllium, thallium, zinc, magnesium, aluminum and manganese. Sulfate deposit material can comprise HSO₄⁻ and/or SO₄²⁻ anions in the solution phase and/or associated with at least one of barium, bismuth, cadmium, calcium, iron, cobalt, copper, silver, strontium, zinc, lead, mercury, nickel, beryllium, thallium, magnesium, aluminum and manganese. Carbonate deposit material can comprise HCO₃¹⁻ and/or CO₃²⁻ anions in the solution phase and/or associated with at least one of barium, bismuth, cadmium, calcium, iron, cobalt, copper, silver, strontium, zinc, lead, mercury, nickel, beryllium, thallium, magnesium, aluminum and manganese. Oxalate deposit material can comprise H(COO)₂¹⁻ and/or (COO)₂²⁻ anions in the solution phase and/or associated with at least one of barium, bismuth, cadmium, calcium, iron, cobalt, copper, silver, strontium, lead, mercury, nickel, beryllium, thallium, zinc, magnesium, aluminum and manganese. Silicate deposit material can comprise H₃SiO₄¹⁻, H₂SiO₄²⁻, HSiO₄³⁻, SiO₄⁴⁻, Si₂O₇⁶⁻, SiₙO₃ₙ²ⁿ⁻, Si₄nO₁₁ₙ⁶ⁿ⁻, and Si₂ₙO₅ₙ²ⁿ⁻ anions, where n is a positive real number, in solution phase and/or as one of serpentine, acmite, gyrolite, gehlenite, silicate, quartz, critobalite, pectrolite, xonotilite, aluminosilicates, analcite, cancrinite, noelite. Phosphate deposit material can comprise H₂PO₄¹⁻, HPO₄²⁻ and PO₄³⁻ anions their analogues in solution phase and/or as one of struvite and hydroxyapatite. Furthermore, as used herein the term phosphate can refer to oxyanions formed from a PO₄ (phosphate) structural unit alone or linked together by sharing oxygen atoms to form a linear chain or cyclic ring structure. Non-limiting examples of phosphates are PO₄³⁻ (phosphate), P₃O₁₀⁵⁻ (triphosphate), PₙO₃ₙ⁽ⁿ⁺²⁾⁻ (polyphosphate), P₃O₉³⁻ (cyclic trimethaphosphate), trimetaphosphate, hexametaphosphate, HPO₃²⁻ (phosphate), H₂P₂O₅²⁻ (pyrophosphites), H₂PO₂⁻ (hypophosphite), one or more of their soluble forms, insoluble forms, acids, or combinations thereof. It can be appreciate that in some embodiments, the silicate and/or phosphate anions can be associated with at least one of barium, bismuth, cadmium, calcium, iron, cobalt, copper, silver, strontium, lead, mercury, nickel, beryllium, thallium, zinc, magnesium, aluminum and manganese.

Preferably, the deposit material may comprise one or more of the following: barium hydrogen phosphate (BaHPO₄), barium pyrophosphate (Ba₂P₂O₇), bismuth phosphate (BiPO₄), cadmium phosphate (Cd₃(PO₄)₂), mono-calcium phosphate (Ca(H₂PO₄)₂), di-calcium phosphate (CaHPO₄), calcium phosphate (Ca₃(PO₄)₂), lead hydrogen phosphate (PbHPO₄), lithium phosphate (Li₃PO₄), magnesium phosphate (Mg₃(PO₄)₂), Nickel phosphate (Ni₂P₇O₇), thallium phosphate (Tl₃PO₄), barium arsenate (Ba₃(ASO₄)₂), bismuth arsenate (BiAsO₄), cadmium arsenate (Cd₃(AsO₄)₂), calcium arsenate (Ca₃(AsO₄)₂), ferric arsenate (FeAsO₄), struvite (NH₄MgPO₄) and a combination thereof. More preferably, the deposit material comprises struvite (NH₄MgPO₄).

In some configurations, the deposit material is in the form of a scale adhered to one or more components of the water handling system. The component may comprise a holding tank, reservoir, pump, aerator, cooling tower, heat exchanger, value, boiler, filtration device, solid liquid and/or gas liquid separator, nozzle, tender, pipe, hose, channel, aqua-duct, ditch, and such of the water handling system. In other configurations, the deposit material may be in the form particulates suspended in water. In yet other configurations, the deposit material may be in a dissolved form, that is, the deposit material is in the form of anions and cations dissolved in water. The anion(s) comprise the anionic component(s) of the deposit material and cation(s) comprise the cationic component(s) of the deposit material.

In some embodiments, the deposit material comprises biological matter. Preferably, the deposit material comprises one or more of bacteria, mold, algae, fungus, virus, or a combination thereof.

### Waters and Water Handling Systems

The water can be any water and/or water handling system. The water handling system can be any system designed and/or used to process and/or convey the water. Non-limiting examples of suitable waters are recreational waters (such as, but not limited to pool, spa and hot tube), municipal waters (such as, drinking, non-potable waters for municipal and/or agricultural use), wastewaters (such as, sewage, industrial and disposal waters), mining waters, drinking waters, well waters, natural and manmade bodies water, and the like. Non-limiting examples of suitable water handling systems are swimming pool water handling systems (such as, pool water filtering, heating/cooling and purification systems), hot tube water handling systems (such as, hot tube water filtering, heating and purification systems), spa water handling systems (such as, spa water filtering, heating/cooling and purification systems), municipal water systems (such as, municipal pumping, filtering, purification, storage and transporting systems), wastewater systems (such as, wastewater pumping, storage, filtering, purification, transporting and disposal systems), mining water handling systems (such as, hydro metallurgical processes and the purification and/or disposal of metallurgical process waters), well water handling systems (such as, potable water wells, agricultural water wells, mineral water wells, and disposal water wells), and combinations thereof.

Typically, the water has a pH value. The pH value of the water to be treated can vary. Commonly, the pH of the water to be treated may be from about pH 0 to about pH 14, more commonly the pH of the water to be treated may be from about pH 1 to about pH 13, even more commonly the pH of the water to be treated may be from about pH 2 to about pH 12, even more commonly the pH of the water to be treated may be from about pH 3 to about pH 11, yet even more commonly the pH of the water to be treated may be from about pH 4 to about pH 10, still yet even more commonly the pH of the water to be treated may be from about pH 5 to about pH 9, or still yet even more commonly the pH of the water to be treated may be from about pH 6 to about pH 8. In some configurations, the pH value of the water is commonly about pH 0, more commonly the pH value of the water is about pH 1, even more commonly the pH value of the water is about pH 2, yet even more commonly the pH value of the water is about pH 3, still yet even more commonly the pH value of the water is about pH 4, still yet even more commonly the pH value of the water is about pH 5, still yet even more commonly the pH value of the water is about pH 6, still yet even more commonly the pH value of the water is about pH 7, still yet even more commonly the pH value of the water is about pH 8, still yet even more commonly the pH value of the water is about pH 9, still yet even more commonly the pH value of the water is about pH 10, still yet even more commonly the pH value of the water is about pH 11, still yet even more commonly the pH value of the water is about pH 12, still yet even more commonly the pH value of the water is about pH 13, or still yet even more commonly the pH value of the water is about pH 14.

Typically, the water has a temperature. The temperature of the water to be treated can vary depending on the water and/or water handling system. Commonly, the temperature of the water is about ambient temperature. Typically, the ambient temperature ranges from about −5 degrees Celsius to about 50 degrees Celsius, more typically from about 0 degrees Celsius to about 45 degrees Celsius, yet even more typically from about 5 degrees Celsius to about 40 degrees Celsius and still yet even more typically from about 10 degrees Celsius to about 35 degrees Celsius. It can be appreciated that the water handling system may include optional processing units and/or operations that heat and/or cool the water. In some configurations the water may be heated to have a temperature of typically at least about 20 degrees Celsius, more typically at least about 25 degrees Celsius, even more typically at least about 30 degrees Celsius, yet even more typically of at least about 35 degrees Celsius, still yet even more typically of at least about 40 degrees Celsius, still yet even more typically of at least about 45 degrees Celsius, still yet even more typically of at least about 50 degrees Celsius, still yet even more typically of at least about 60 degrees Celsius, still yet even more typically of at least about 70 degrees Celsius, still yet even more typically of at least about 80 degrees Celsius, still yet even more typically of at least about 90 degrees Celsius, still yet even more typically of at least about 100 degrees Celsius, still yet even more typically of at least about 110 degrees Celsius, still yet even more typically of at least about 120 degrees Celsius, still yet even more typically of at least about 140 degrees Celsius, still yet even more typically of at least about 150 degrees Celsius, or still yet even more typically of at least about 200 degrees Celsius. In some configurations, the water may be cooled to have a temperature of typically of no more than about 110 degrees Celsius, more typically of no more than about 100 degrees Celsius, even more typically of no more than about 90 degrees Celsius, yet even more typically of no more than about 80 degrees Celsius, still yet even more typically of no more than about 70 degrees Celsius, still yet even more typically of no more than about 60 degrees Celsius, still yet even more typically of no more than about 50 degrees Celsius, still yet even more typically of no more than about 45 degrees Celsius, still yet even more typically of no more than about 40 degrees Celsius, still yet even more typically of no more than about 35 degrees Celsius, still yet even more typically of no more than about 30 degrees Celsius, still yet even more typically of no more than about 25 degrees Celsius, still yet even more typically of no more than about 20 degrees Celsius, still yet even more typically of no more than about 15 degrees Celsius, still yet even more typically of no more than about 10 degrees Celsius, still yet even more typically of no more than about 5 degrees Celsius, or still yet even more typically of no more than about 0 degrees Celsius.

### Rare Earth(s) and Rare Earth-Containing Additive

The rare earth-containing additive comprises a rare earth and/or rare earth-containing composition. The rare earth-containing additive is capable of substantially, if not entirely, removing the deposit material and/or inhibiting disposition of the deposit material from the water and/or water handling system. In other words, the rare earth-containing additive is capable of substantially reducing the scaling tendency of the water.

The rare earth and/or rare earth-containing composition in the rare earth-containing additive can be rare earths in elemental, ionic or compounded forms. The rare earth and/or rare earth-containing composition can be dissolved in a solvent, such as water, or in the form of nanoparticles, particles larger than nanoparticles, agglomerates, or aggregates or combinations and/or mixtures thereof. The rare earth and/or rare earth-containing composition can be supported or unsupported. The rare earth and/or rare earth-containing composition can comprise one or more rare earths. The rare earths may be of the same or different valence and/or oxidation states and/or numbers. The rare earths can be a mixture of different rare earths, such as two or more of yttrium, scandium, cerium, lanthanum, praseodymium, and neodymium. The rare earth and/or rare earth-containing composition commonly includes cerium (III) and/or (IV), with a water-soluble cerium (III) salt being more common.

The rare earth-containing composition comprising the rare earth-containing additive may be water-soluble or water-insoluble. Commonly, the rare earth-containing composition comprises one or more rare earth(s) having +3, +4, or a mixture of +3 and +4 oxidation states. For example, the mixture of water-soluble rare earth-containing compositions can comprise a first rare earth having a +3 oxidation state and a second rare earth having a +4 oxidation state. The first and second rare earths may have the same or differing atomic numbers. In some embodiments, the first and second rare earths are the same and comprise cerium. More specifically, the first rare earth comprises cerium (III) and the second rare earth comprises cerium (IV). In many applications, the cerium is primarily in the form of a water-soluble cerium (III) salt, with the remaining cerium being present as cerium oxide, a substantially water insoluble cerium composition. In some applications, the water-soluble cerium composition comprises cerium (III) chloride, CeCl₃. In a preferred embodiment, the rare earth-containing additive substantially comprises cerium (III) chloride, more preferred is an aqueous solution of cerium (III) chloride.

For rare earth-containing additives having a mixture of +3 and +4 oxidations states commonly at least some of the rare earth has a +3 oxidation state, more commonly at least most of the rare earth has a +3 oxidation state, more commonly at least about 75 wt. % of the rare earth has a +3 oxidation state, even more commonly at least about 90 wt. % of the rare earth has a +3 oxidation state, or yet even more commonly at least about 98 wt. % of the rare earth has a +3 oxidation state. The rare earth-containing additive commonly includes at least about 1 ppm, even more commonly at least about 10 ppm and yet even more commonly at least about 100 ppm cerium (IV) oxide. While in some embodiments, the rare earth-containing additive includes at least about 0.0001 wt. % cerium (IV), commonly at least about 0.001 wt. % cerium (IV) and even more commonly at least about 0.01 wt. % cerium (IV) calculated as cerium oxide. Moreover, in some embodiments, the rare earth-containing additive commonly has at least about 250,000 pm cerium (III), more commonly at least about 100,000 ppm cerium (III) and even more commonly at least about 20,000 ppm cerium (III).

In one formulation, the rare earth-containing additive is water-soluble and commonly includes one or more rare earths, such as cerium and/or lanthanum, having a +3 oxidation state. Non-limiting examples of suitable water-soluble rare earth-containing compositions include rare earth halides, rare earth nitrates, rare earth sulfates, rare earth oxalates, rare earth perchlorates, rare earth carbonates, and mixtures thereof.

In some formulations, the water-soluble cerium-containing additive contains, in addition to cerium, other trivalent rare earths (such as one or more of lanthanum, neodymium, praseodymium and samarium). The molar ratio of cerium (III) to the other trivalent rare earths is commonly at least about 1:1, more commonly at least about 10:1, more commonly at least about 15:1, more commonly at least about 20:1, more commonly at least about 25:1, more commonly at least about 30:1, more commonly at least about 35:1, more commonly at least about 40:1, more commonly at least about 45:1, and more commonly at least about 50:1.

In some formulations, the water-soluble cerium-containing additive contains, in addition to cerium, one or more of lanthanum, neodymium, praseodymium and samarium. The water-soluble rare earth-containing additive commonly includes at least about 0.01 wt. % of one or more of lanthanum, neodymium, praseodymium and samarium. The water-soluble rare earth-containing additive commonly has on a dry basis no more than about 10 wt. % La, more commonly no more than about 9 wt. % La, even more commonly no more than about 8 wt. % La, even more commonly no more than about 7 wt. % La, even more commonly no more than about 6 wt. % La, even more commonly no more than about 5 wt. % La, even more commonly no more than about 4 wt. % La, even more commonly no more than about 3 wt. % La, even more commonly no more than about 2 wt. % La, even more commonly no more than about 1 wt. % La, even more commonly no more than about 0.5 wt. % La, and even more commonly no more than about 0.1 wt. % La. The water-soluble rare earth-containing additive commonly has on a dry basis no more than about 8 wt. % Nd, more commonly no more than about 7 wt. % Nd, even more commonly no more than about 6 wt. % Nd, even more commonly no more than about 5 wt. % Nd, even more commonly no more than about 4 wt. % Nd, even more commonly no more than about 3 wt. % Nd, even more commonly no more than about 2 wt. % Nd, even more commonly no more than about 1 wt. % Nd, even more commonly no more than about 0.5 wt. % Nd, and even more commonly no more than about 0.1 wt. % Nd. The water-soluble rare earth-containing additive commonly has on a dry basis no more than about 5 wt. % Pr, more commonly no more than about 4 wt. % Pr, even more commonly no more than about 3 wt. % Pr, even more commonly no more than about 2.5 wt. % Pr, even more commonly no more than about 2.0 wt. % Pr, even more commonly no more than about 1.5 wt. % Pr, even more commonly no more than about 1.0 wt. % Pr, even more commonly no more than about 0.5 wt. % Pr, even more commonly no more than about 0.4 wt. % Pr, even more commonly no more than about 0.3 wt. % Pr, even more commonly no more than about 0.2 wt. % Pr, and even more commonly no more than about 0.1 wt. % Pr. The water-soluble rare earth-containing additive commonly has on a dry basis no more than about 3 wt. % Sm, more commonly no more than about 2.5 wt. % Sm, even more commonly no more than about 2.0 wt. % Sm, even more commonly no more than about 1.5 wt. % Sm, even more commonly no more than about 1.0 wt. % Sm, even more commonly no more than about 0.5 wt. % Sm, even more commonly no more than about 0.4 wt. % Sm, even more commonly no more than about 0.3 wt. % Sm, even more commonly no more than about 0.2 wt. % Sm, even more commonly no more than about 0.1 wt. % Sm, even more commonly no more than about 0.05 wt. % Sm, and even more commonly no more than about 0.01 wt. % Sm.

In some formulations, a water-soluble lanthanum-containing additive contains, in addition to lanthanum, other trivalent rare earths (including one or more of cerium, neodymium, praseodymium and samarium). The molar ratio of lanthanum (III) to other trivalent rare earths is commonly at least about 1:1, more commonly at least about 10:1, more commonly at least about 15:1, more commonly at least about 20:1, more commonly at least about 25:1, more commonly at least about 30:1, more commonly at least about 35:1, more commonly at least about 40:1, more commonly at least about 45:1, and more commonly at least about 50:1.

In some embodiments, the water-soluble rare earth-containing additive comprises one or more nitrogen-containing materials. The one or more nitrogen-containing materials, commonly, comprise one or more of ammonia, an ammonium-containing composition, a primary amine, a secondary amine, a tertiary amine, an amide, a cyclic amine, a cyclic amide, a polycyclic amine, a polycyclic amide, and combinations thereof. The nitrogen-containing materials are typically less than about 1 ppm, less than about 5 ppm, less than about 10 ppm, less than about 25 ppm, less than about 50 ppm, less about 100 ppm, less than about 200 ppm, less than about 500 ppm, less than about 750 ppm or less than about 1000 ppm of the water-soluble rare earth-containing additive. Commonly, the rare earth-containing additive comprises a water-soluble cerium (III) and/or lanthanum (III) composition. More commonly, the water-soluble rare earth-containing additive comprises cerium (III) chloride. The rare earth-containing additive is typically dissolved in a liquid.

In one formulation, the rare earth-containing additive consists essentially of a water-soluble cerium (III) salt, such as a cerium (III) chloride, cerium (III) bromide, cerium (III) iodide, cerium (III) astatide, cerium perhalogenates, cerium (III) carbonate, cerium (III) nitrate, cerium (III) sulfate, cerium (III) oxalate and mixtures thereof. The rare earth in this formulation commonly is primarily cerium (III), more commonly at least about 75 mole % of the rare earth content of the rare earth-containing additive is cerium (III), that is no more than about 25 mole % of the rare earth content of the rare earth-containing additive comprises rare earths other than cerium (III). Even more commonly, the rare earth in this formulation commonly is primarily at least about 80 mole % cerium (III), yet even more commonly at least about 85 mole % cerium (III), still yet even more commonly at least about 90 mole % cerium (III), and yet still even more commonly at least about 95 mole % cerium (III).

For rare earth-containing additives having a mixture of +3 and +4 oxidations states commonly at least some of the rare earths have a +3 oxidation state, more commonly at least most of the rare earths have a +3 oxidation state, more commonly at least about 75 wt. % of the rare earths have a +3 oxidation state, even more commonly at least about 90 wt. % of the rare earths have a +3 oxidation state, or yet even more commonly at least about 98 wt. % of the rare earths have a +3 oxidation state. The rare earth-containing additive commonly includes at least about 1 ppm, even more commonly at least about 10 ppm and yet even more commonly at least about 100 ppm cerium (IV) oxide. While in some embodiments, the rare earth-containing additive includes at least about 0.0001 wt. % cerium (IV), commonly at least about 0.001 wt. % cerium (IV) and even more commonly at least about 0.01 wt. % cerium (IV) calculated as cerium oxide. Moreover, in some embodiments, the rare earth-containing additive commonly has at least about 250,000 pm cerium (III), more commonly at least about 100,000 ppm cerium (III) and even more commonly at least about 20,000 ppm cerium (III).

In another formulation, the rare earth-containing additive contains at least some water-soluble cerium (IV) salt, such as cerium (IV) sulfate (e.g., ceric ammonium sulfate and ceric sulfate), cerium (IV) nitrate (e.g., ceric ammonium nitrate), cerium (IV) oxyhydroxide, cerium (IV) hydrous oxide and mixtures thereof. In this formulation, the cerium (IV) content, based on the total rare content of the rare earth-containing additive, is commonly is no more than about 75 mole % cerium (IV), more commonly no more than about 50 mole % cerium (IV), even more commonly no more than about 40 mole % cerium (IV), yet even more commonly no more than about 30 mole % cerium (IV), still yet even more commonly no more than about 25 mole % cerium (IV), still yet even more commonly no more than about 20 mole % cerium (IV), still yet even more commonly no more than about 15 mole % cerium (IV), still yet even more commonly no more than about 10 mole % cerium (IV), still yet even more commonly no more than about 5 mole % cerium (IV), or still yet even more commonly no more than about 2 mole % cerium (IV). It can be appreciated that, a rare earth-containing additive having only cerium (IV) as the rare earth would have 100 mole % cerium (IV) and a rare earth-containing additive lacking cerium (IV) would have 0 mole % cerium (IV).

In some embodiments, the rare earth-containing additive can in the form of one or more of: an aqueous solution containing substantially dissociated, dissolved forms of the rare earths and/or rare earth-containing compositions; free flowing granules, powder, particles, and/or particulates of rare earths and/or rare earth-containing compositions containing at least some water-soluble cerium (III); free flowing aggregated granules, powder, particles, and/or particulates of rare earths and/or rare earth-containing compositions substantially free of a binder and containing at least some water-soluble cerium (III); free flowing agglomerated granules, powder, particles, and/or particulates comprising a binder and rare earths and/or rare earth-containing compositions one or both of in an aggregated and non-aggregated form and containing at least some water-soluble cerium (III); rare earths and/or rare earth-containing compositions containing at least some water-soluble cerium (III) and supported on substrate; and combinations thereof.

Further regarding the above embodiments, the rare earth-containing additive may comprise a mixture of water-soluble rare earth-containing compositions having one or both of differing rare earths and/or rare earth oxidation states. The differing rare earth oxidation states may be used to substantially reduce the scaling tendency of the water by one or both of removing some or all of the deposit material in the water and/or water handling system and/or inhibiting deposition of the deposit material in the water handling system.

In another formulation, the rare earth-containing additive consists essentially of a water insoluble cerium (IV) composition, particularly cerium (IV) oxide, and/or cerium (IV) oxide in combination with other rare earths (such as, but not limited to one or more of lanthanum, praseodymium, yttrium, scandium, neodymium, samarium, europium, gadolinium, terbium, dysprosium, holmium, erbium, thulium, ytterbium and lutetium). The rare earth in this formulation commonly is primarily cerium (IV) oxide, more commonly at least about 75 mole % of the rare earth content of the rare earth-containing additive is cerium (IV), more commonly at least about 80 mole % cerium (IV), more commonly at least about 85 mole % cerium (IV), more commonly at least about 90 mole % cerium (IV), and even more commonly at least about 95 mole % cerium (IV) present in the form of cerium oxide (CeO₂).

In some embodiments, the water insoluble rare earth-containing additive may be in the form of a colloid, suspension, or slurry of particulates. The particulates can have an average particle size commonly of less than about 1 nanometer, more commonly from about 1 nanometer to about 1,000 nanometers, even more commonly from about 1 micron to about 1,000 microns, or yet even more commonly of at least about 1,000 microns.

In some embodiments, rare earth-containing additive may have a surface area of at least about 1 m²/g, preferably a surface area of at least about 70 m²/g. In other embodiments, the insoluble rare earth-containing additive may preferably have a surface area from about 25 m²/g to about 500 m²/g and more preferably, a surface area of about 100 to about 250 m²/g.

The rare earth-containing additive is, in one application, not a naturally occurring mineral but is synthetically manufactured. Exemplary naturally occurring rare earth-containing minerals include bastnasite (a carbonate-fluoride mineral) and monazite. Other naturally occurring rare earth-containing minerals include aeschynite, allanite, apatite, britholite, brockite, cerite, fluorcerite, fluorite, gadolinite, parisite, stillwellite, synchisite, titanite, xenotime, zircon, and zirconolite. Exemplary uranium minerals include uraninite (UO₂), pitchblende (a mixed oxide, usually U₃O₈), brannerite (a complex oxide of uranium, rare-earths, iron and titanium), coffinite (uranium silicate), carnotite, autunite, davidite, gummite, torbernite and uranophane. In one formulation, the rare earth and/or rare earth-containing additive is substantially free of one or more elements in Group 1, 2, 4-15, or 17 of the Periodic Table, a radioactive species, such as uranium, sulfur, selenium, tellurium, and polonium.

The rare earth and/or rare earth-containing additive may be in the form of one or more of a granule, powder, crystal, crystallite, particle and particulate, preferably in the form of a free-flowing granule, powder, and particulate. More preferably, the rare earth-containing additive comprises crystals or crystallites. Typically, the rare earth-containing crystals or crystallites comprise nano-crystals, nano-crystallites and/or nanocrystalline domains. The rare earth-containing additive free flowing granule, powder, and/or particulate may have a mean, median, and/or P₉₀ particle size of at least about 0.5 nm, ranging up to about 1 μm or more. More typically, the rare earth-containing additive has a mean, median and/or P₉₀ particle size of at least about 1 nm, in some cases at least about 5 nm, in other cases, at least about 10 nm, and still other cases at least about 25 nm, and in yet still other cases at least about 50 nm. In other embodiments, the rare earth-containing additive has a mean, median, and/or P₉₀ particle size in the range of from about 50 nm to about 500 microns and in still other embodiments in the range of from about 50 nm to about 500 nm. The rare earth-containing additive typically is at least about 75 wt. %, more typically at least about 80 wt. %, more typically at least about 85 wt. %, more typically at least about 90 wt. %, more typically at least about 95 wt. %, and even more typically at least about 99 wt. % rare earth compound(s), the remainder being compounds and/or materials devoid of a rare earth.

Furthermore, the rare earth-containing additive may comprise rare earth-containing granules, powder, particles, and/or particulates agglomerated and/or aggregated together with or without a binder. The rare earth-containing agglomerates and/or aggregates can be formed through one or more of extrusion, molding, calcining, sintering, and compaction. In one formulation, the rare earth-containing additive is a free flowing, rare earth-containing agglomerate comprising a binder and rare earth-containing particulates. Preferably, the rare earth-containing particulates are in the form of powder and have aggregated nanocrystalline domains.

The rare earth-containing agglomerates and/or aggregates can be in the form of a granule, a bead, a pellet, a powder, a fiber, or a similar form. In most applications, the rare earth-containing agglomerates and/or aggregates commonly have a mean, median, or P₉₀ particle size of at least about 1 μm, more commonly at least about 5 μm, more commonly at least about 10 μm, still more commonly at least about 25 μm. In other applications, the rare earth-containing agglomerates or aggregates have a mean, median, or P₉₀ particle size distribution from about 100 to about 5,000 microns; a mean, median, or P₉₀ particle size distribution from about 200 to about 2,500 microns; a mean, median, or P₉₀ particle size distribution from about 250 to about 2,500 microns; or a mean, median, or P₉₀ particle size distribution from about 300 to about 500 microns. In yet other applications, the agglomerates and/or aggregates can have a mean, median, or P₉₀ particle size distribution of at least about 100 nm, specifically at least about 250 nm, more specifically at least about 500 nm, even more specifically at least about 1 μm and yet even more specifically at least about 0.5 nm, the mean, median, or P₉₀ particle size distribution of the agglomerates and/or aggregates can be up to about 1 micron or more.

Specifically, the rare earth-containing particulates, individually and/or in the form of agglomerates and/or aggregates, can have in some cases a surface area of at least about 5 m²/g, in other cases at least about 10 m²/g, in other cases at least about 70 m²/g, in yet other cases at least about 85 m²/g, in still yet other cases at least about 100 m²/g, in still yet other cases at least about 115 m²/g, in still yet other cases at least about 125 m²/g, in still yet other cases at least about 150 m²/g, in still yet other cases at least 300 m²/g, and in still yet other cases at least about 400 m²/g. In some configurations, the rare earth-containing particulates, individually and/or in the form of agglomerates or aggregates commonly can have a surface area from about 50 to about 500 m²/g, or more commonly from about 110 to about 250 m²/g.

In one formulation, the rare earth-containing agglomerates and/or aggregates include an insoluble rare earth-containing composition and a water-soluble rare earth-containing composition. Commonly, the insoluble rare earth-containing composition comprises cerium (III) oxide, cerium (IV) oxide, and mixtures thereof. The water-soluble rare earth-containing composition is commonly one or more of a cerium (III), cerium (IV) and lanthanum (III) salts. Cerium (III) carbonate, cerium (III) chloride, cerium (III) bromide, cerium (III) iodide, cerium (III) astatide, cerium (III) nitrate, cerium (III) sulfate, cerium (III) oxalate, and cerium (III) perchlorate are non-limiting examples of water-soluble cerium (III) salts. Non-limiting examples of water-soluble cerium (IV) salts are cerium (IV) ammonium sulfate, cerium (IV) acetate, cerium (IV) chloride, cerium (IV) bromide, cerium (IV) iodide, cerium (IV) astatide, cerium (IV) oxalate, cerium (IV) perchlorate, and cerium (IV) sulfate. Lanthanum (III) carbonate, lanthanum (III) chloride, lanthanum (III) bromide, lanthanum (III) iodide, lanthanum (III) astatide, lanthanum (III) nitrate, lanthanum (III) sulfate, lanthanum (III) oxalate, lanthanum (III) oxide, and lanthanum (III) perchlorate are non-limiting examples of water-soluble lanthanum salts.

The binder can include one or more polymers selected from the group consisting of thermosetting polymers, thermoplastic polymers, elastomeric polymers, cellulosic polymers and glasses. Binders include polymeric and/or thermoplastic materials that are capable of softening and becoming “tacky” at elevated temperatures and hardening when cooled. The polymers forming the binder may be in a dry powder and/or pellet form, or in an aqueous emulsion and/or suspension. Furthermore, the polymers forming the binder may be provided in the form of an emulsion, suspension, or dispersion.

The rare earth-containing agglomerate and/or aggregate composition can vary depending on of the process for making and/or using the rare earth-containing agglomerate and/or aggregate.

Commonly, the rare earth-containing agglomerate includes more than 10.01 wt. %, more commonly more than about 85 wt. %, even more commonly more than about 90 wt. %, yet even more commonly more than about 92 wt. % and still yet even more commonly from about 95 to about 96.5 wt. % rare earth-containing particulates, with the balance being primarily the binder. Stated another way, the binder can be less than about 15% by weight of the agglomerate, in some cases less than about 10% by weight, in still other cases less than about 8% by weight, in still other cases less than about 5% by weight, and in still other cases less than about 3.5% by weight of the agglomerate.

In another formulation, the rare earth-containing additive includes a rare earth-containing composition supported on, coated on, or incorporated into a substrate, preferably the rare earth-containing composition is in the form of particulates. The rare earth-containing particulates can, for example, be supported or coated on the substrate with or without a binder. The binder may be any suitable binder, such as those set forth herein.

Suitable substrates can include porous and fluid permeable solids having a desired shape and physical dimensions. The substrate, for example, can be a sintered ceramic, sintered metal, microporous carbon, glass fiber, cellulosic fiber, alumina, gamma-alumina, activated alumina, acidified alumina, a metal oxide containing labile anions, crystalline alumino-silicate such as a zeolite, amorphous silica-alumina, ion exchange resin, clay, ferric sulfate, porous ceramic, and the like. Such substrates can be in the form of mesh, as screens, tubes, honeycomb structures, monoliths, and blocks of various shapes, including cylinders and toroids. The structure of the substrate will vary depending on the application but can include a woven substrate, non-woven substrate, porous membrane, filter, fabric, textile, or other fluid permeable structure. The rare earth-containing additive can be incorporated into or coated onto a filter block or monolith for use in a filter, such as a cross-flow type filter. The rare earth and/or rare earth-containing additive can be in the form of particles coated on to or incorporated in the substrate or can be ionically substituted for cations in the substrate.

Typically, the rare earth-coated substrate comprises at least about 0.1% by weight, more typically 1% by weight, more typically at least about 5% by weight, more typically at least about 10% by weight, more typically at least about 15% by weight, more typically at least about 20% by weight, more typically at least about 25% by weight, more typically at least about 30% by weight, more typically at least about 35% by weight, more typically at least about 40% by weight, more typically at least about 45% by weight, and more typically at least about 50% by weight rare earth and/or rare earth-containing composition. Typically, the rare earth-coated substrate includes no more than about 95% by weight, more typically no more than about 90% by weight, more typically no more than about 85% by weight, more typically no more than about 80% by weight, more typically no more than about 75% by weight, more typically no more than about 70% by weight, and even more typically no more than about 65% by weight rare earth and/or rare earth-containing composition.

It should be noted that it is not required to formulate the rare earth-containing additive with either a binder or a substrate, though such formulations may be desired depending on the application.

In some embodiments, a filtering device comprising an insoluble rare earth additive may remove the deposit material. The filter may comprise cerium dioxide, supported on or contained with a matrix comprising a polymeric material, such as, but not limited to a fluorocarbon-containing polymer and/or an acrylic-polymer. More commonly, the rare earth additive comprises cerium (4+), even more commonly, cerium dioxide.

### Deposit Removal/Inhibition Process

The rare earth-containing additive can remove and/or inhibit deposition of the deposit material from the water and/or water handling system. While not wanting to be bound by any theory, the rare earth-containing additive can remove and/or inhibit deposition of the deposit material from the water and/or water handling system by many possible mechanisms.

In accordance with some embodiments, a rare earth-containing additive is contacted with a deposit material contained within a water and/or water handling system. The rare earth-containing additive may comprise a water-soluble rare earth-containing composition, a water-insoluble rare earth-containing composition or a mixture of water-soluble and water-insoluble rare earth-containing compositions. Preferably, the rare earth-containing additive comprises one or more water-soluble rare earth-containing compositions. More preferably, at least one of the water-soluble rare earth-containing compositions comprises cerium (III) chloride and/or lanthanum (III) chloride.

In accordance with some embodiments, the contacting of the rare earth-containing additive with the deposit material substantially removes at least some, if not most, of the deposit material and/o inhibits deposition of deposit material from the water and/or water handling system. In some configurations, the contacting of the rare earth-containing additive with the deposit material forms a deposit-laden rare earth composition.

Commonly, the rare earth-containing composition comprises a rare earth +3 cation. More commonly, the rare earth +3 cation is one or more of cerium +3, lanthanum +3 and praseodymium +3. Preferably, the rare earth +3 cation is in dissociated, dissolved state. More preferably, the rare earth +3 cation is dissolved in an aqueous solution.

In accordance with some embodiments, the deposit material comprises an anion, preferably an oxyanion. Even more preferably, the deposit material comprises an oxyanion of an element selected from group 15 of the periodic table. Furthermore, common anions of Group 15 are oxyanions of nitrogen, phosphorous, arsenic, antimony, bismuth and mixtures thereof. More common anions of Group 15 are the oxyanions comprising phosphate, arsenate, arsenite, nitrate, nitrite, antimonate, bismuthate and mixtures thereof.

While not wishing to be bound by any theory, it is believed that the deposit material anion is removed and/or inhibited from deposition from the water and/or water handling system by sorption (that is, adsorption, absorption and/or precipitation) by the rare earth-containing additive. More specifically, the Group 15 oxyanion is removed from the water and/or water handling system as a deposit-laden rare earth composition, preferably a substantially insoluble deposit-laden rare earth composition. Preferably, the insoluble deposit-laden rare earth composition comprises a rare earth +3 cation and an oxyanion. More preferably, the insoluble deposit-laden rare earth composition comprises cerium (+3) and an oxyanion.

The deposit-laden rare earth composition can have a rare earth:oxyanion ratio. The rare earth:oxyanion ratio can vary. While not wanting to be limited by theory and/or example, deposit-laden rare earth compositions having a rare earth:oxyanion ratio less than 1 have a greater molar removal capacity of oxyanion than rare earths having a rare earth:oxyanion ratio of 1 or more.

It is believed that the rare:oxyanion ratio can vary depending on pH value of the water. In some embodiments, the rare earth:oxyanion ratio increases as the pH value of the water increases. In some embodiments, the rare earth:oxyanion ratio decreases with decreases in the pH value of the water. In other embodiment, the rare earth:oxyanion ratio is substantially unchanged over a range of water pH values.

In some embodiments, the rare earth:oxyanion ratio is no more than about 0.1, the rare earth:oxyanion ratio is no more than about 0.2, the rare earth:oxyanion ratio is no more about 0.3, the rare earth:oxyanion ratio is no more than about 0.4, the rare earth:oxyanion ratio is no more than about 0.5, the rare earth:oxyanion ratio is no more than about 0.6, the rare earth:oxyanion ratio is no more than about 0.7, the rare earth:oxyanion ratio is no more than about 0.8, the rare earth:oxyanion ratio is no more than about 0.9, the rare earth:oxyanion ratio is no more than about 1.0, the rare earth:oxyanion ratio is no more than about 1.1, the rare earth:oxyanion ratio is no more than about 1.2, the rare earth:oxyanion ratio is no more than about 1.3, the rare earth:oxyanion ratio is no more than about 1.4, the rare earth:oxyanion ratio is no more than about 1.5, the rare earth:oxyanion ratio is no more than about 1.6, the rare earth:oxyanion ratio is no more than about 1.7, the rare earth:oxyanion ratio is no more about 1.8, the rare earth:oxyanion ratio is no more than about 1.9, the rare earth:oxyanion ratio is no more than about 1.9, or the rare earth:oxyanion ratio is more than about 2.0 at a water pH value of no more than about pH −2, at a water pH value of more than about pH −1, at a water pH value of more than about pH 0, at a water pH value of more than about pH 1, at a water pH value of more than about pH 2, at a water pH value of more than about pH 3, at a water pH value of more than about pH 4, at a water pH value of more than about pH 5, at a water pH value of more than about pH 6, at a water pH value of more than about pH 7, at a water pH value of more than about pH 8, at a water pH value of more than about pH 9, at a water pH value of more than about pH 10, at a water pH value of more than about pH 11, at a water pH value of more than about pH 12, at a water pH value of more than about pH 13, or at a water pH value of more than about pH 14.

In some embodiments, having a rare earth-containing additive that forms an aqueous phase +3 rare earth is advantageous. For example, having an aqueous phase rare earth (+3) provides for an opportunity to take advantage of rare earth (+3) solution phase sorption and/or precipitation chemistries, such as, but not limited to, the formation of insoluble rare earth (+3) compositions with oxyanions. While not wanting to be limited by theory, it is believed that the solution phase rare earth (+3) is substantially dissolved in the aqueous solution and is present as a rare earth (+3) ion. The strong interaction of the +3 rare earth with arsenate is an example of the formation of insoluble rare earth (+3) oxyanion composition. The +3 rare earth may comprise one or more of yttrium (+3), lanthanum (+3), cerium (+3), praseodymium (+3), samarium (+3), europium (+3), gadolinium (+3), terbium (+3), dysprosium (+3), holmium (+3), erbium (+3), thulium (+3), ytterbium (+3), and lutetium (+3). Preferably, the +3 rare earth comprises cerium (+3).

In some embodiments, having a rare earth-containing additive comprising +3 and +4 rare earths is advantageous. More specifically, having a cerium-containing additive comprising cerium (+3) and cerium (+4) is advantageous. For example, having solution phase cerium (+3) provides for an opportunity to take advantage of cerium (+3) solution phase sorption and/or precipitation chemistries, such as, hut not limited to, the formation of insoluble cerium (+3) compositions with oxyanions. While not wanting to be limited by theory, it is believed that the solution phase cerium (+3) is substantially dissolved in the aqueous solution and is present as a cerium (+3) ion. The strong interaction of cerium +3 with arsenate is an example of the formation of insoluble cerium (+3) oxyanion composition. Furthermore, having a cerium (+4)-containing composition present provides for an opportunity to take advantage of sorption and oxidation/reduction chemistries of cerium (+4), such as, the strong interaction of cerium (+4) to form substantially insoluble deposit-laden cerium (IV) compositions. A non-limiting example of such a substantially deposit-laden cerium (IV) composition is cerium (IV) arsenite. Common, non-limiting examples of cerium (IV)-containing compositions are: cerium (IV) dioxide, cerium (IV) oxide, cerium (IV) oxyhydroxide, cerium (IV) hydroxide, and hydrous cerium (IV) oxide. Moreover, the oxidation state or number of a rare earth in the rare earth-containing additive can have a significant impact on its efficacy in removing and/or inhibiting deposit materials. Cerium (III) and cerium (IV), for example, can have dramatically different capacities or abilities to remove and/or inhibit deposit materials. Although cerium (III) and cerium (IV) both can remove phosphates, cerium (IV), and cerium (IV) oxide in particular, is generally more efficacious than cerium (III) in removing phosphate and aresenite than cerium (III). For example, cerium (IV) oxide, but not cerium (III), can remove arsenite, and, though both cerium (IV) oxide and cerium (III) can remove arsenate, cerium (III) appears to hold arsenate more tightly than cerium (IV) oxide.

In many applications, cerium is highly effective in removing and/or inhibiting deposition of deposit materials comprising oxyanions. In preferred applications, cerium is highly effective in removing and/or inhibiting deposition of deposit material comprising one or more of phosphate, arsenate, or arsenite. While not wanting to be limited by example, cerium (III) phosphate (CePO₄) has a 1:1 molar ratio and cerium (IV) phosphate (Ce₃(PO₄)₄) has a 1:1.3 molar ratio of cerium to PO₄³⁻. Furthermore, cerium has a 1:1 molar ratio of cerium (III) to both arsenate and arsenite, while cerium (IV) a 1:1.3 molar ratio of cerium (IV) to both arsenate and arsenite.

However, contacting water-soluble cerium (III), derived from CeCl₃, with a phosphate-, arsenate-, arsenite-, antimonate-, bismuthate-containing deposit material produces a deposit-laden cerium composition, typically in the form the deposit-laden cerium composition is in the form of a precipitate having a cerium to oxyanion ratio from about 1:1.3 to about 1:2.6, more commonly from about 1:1.3 to about 1:1, and even more commonly from about 1:1.3 to about 1:1.5. It can be appreciated that the oxyanion comprises one phosphate, arsenate, arsenite, antimonite, bismuthate or one of their protonated forms, or mixture thereof.

While not wishing to be bound by any theory, it is believed that the precipitate formed by contacting a water-soluble cerium (III) salt with a phosphate-containing aqueous solution is a mixture of CePO₄ and Ce₃(PO₄)₄. The cerium may be a substantially water-soluble cerium-containing composition or a substantially water insoluble cerium-containing composition.

In some embodiments, a molar ratio of a water-soluble to a water-insoluble rare earth in the water and/or water handling system is commonly no more than about 1:1, more commonly is no more than about 1:5×10⁻¹, even more commonly is no more than about 1:1×10⁻¹, yet even more commonly is no more than about 1:1×10⁻², still yet even more commonly is no more than about 1:1×10⁻³, still yet even more commonly is no more than about 1:1×10⁻⁴, still yet even more commonly is no more than about 1:1×10⁻⁵, or still yet even more commonly is no more than about 1:1×10⁻⁶. The water-soluble and water-insoluble rare earths may be the same or different rare earths. Furthermore, the molar ratios refer to the rare earths water-soluble and water-insoluble rare earths that are free of and/or not attached to a deposit material. That is, the molar ratios do not include rare earths attached and/or associated with a deposit material.

In some embodiments, a molar ratio of a water-soluble trivalent rare earth (RE (III)) to a tetravalent insoluble rare earth (RE (IV)) in the water and/or water handling system commonly is no more than about 1:1, more commonly is no more than about 1:5×10⁻¹, even more commonly is no more than about 1:1×10⁻¹, yet even more commonly is no more than about 1:1×10⁻², still yet even more commonly is no more than about 1:1×10⁻³, still yet even more commonly is no more than about 1:1×10⁻⁴, still yet even more commonly is no more than about 1:1×10⁻⁵, or still yet even more commonly is no more than about 1:1×10⁻⁶. The water-soluble trivalent rare earth and water-insoluble tetravalent insoluble rare earth may be the same or different rare earths. Furthermore, the molar ratios refer to the trivalent water-soluble and tetravalent insoluble rare earths that are free of and/or not attached to a deposit material. That is, the molar ratios do not include rare earths attached and/or associated with a deposit material.

In some embodiments, the molar ratio of cerium (III) to cerium (IV) contained in the water and/or water handling system commonly is no more than about 1:1, more commonly is no more than about 1:5×10⁻¹, even more commonly is no more than about 1:1×10⁻¹, yet even more commonly is no more than about 1:1×10⁻², still yet even more commonly is no more than about 1:1×10⁻³, still yet even more commonly is no more than about 1:1×10⁻⁴, still yet even more commonly is no more than about 1:1×10⁻⁵, or still yet even more commonly is no more than about 1:1×10⁻⁶. In some embodiments, the molar ratio of cerium (+3) to cerium (+4) in the rare earth-containing composition is about 1 to about 1×10⁻⁷, more commonly is about 1 to about 1×10⁻⁶, even more commonly is about 1 to about 1×10⁻⁶, yet even more commonly is about 1 to about 1×10⁻⁴, still yet even more commonly is about 1 to about 1×10⁻³, still yet even more commonly is about 1 to about 1×10²⁻, still yet even more commonly is about 1 to about 1×10⁻¹, or still yet even more commonly is about 1:1.

In some embodiments, the molar ratio of cerium (IV) to cerium (III) contained in the water and/or water handling system commonly is no more than about 1:1, more commonly is no more than about 1:5×10⁻¹, even more commonly is no more than about 1:1×10⁻¹, yet even more commonly is no more than about 1:1×10⁻², still yet even more commonly is no more than about 1:1×10⁻³, still yet even more commonly is no more than about 1:1×10⁻⁴, still yet even more commonly is no more than about 1:1×10⁻⁵, or still yet even more commonly is no more than about 1:1×10⁻⁶. In some embodiments, the molar ratio of cerium (+4) to cerium (+3) in the rare earth-containing composition is about 1 to about 1×10⁻⁷, more commonly is about 1 to about 1×10⁻⁶, even more commonly is about 1 to about 1×10⁻⁵, yet even more commonly is about 1 to about 1×10⁻⁴, still yet even more commonly is about 1 to about 1×10⁻³, still yet even more commonly about 1 to about 1×10⁻², still yet even more commonly is about 1 to about 1×10⁻¹, or still yet even more commonly is about 1:1.

Further, the molar ratios of cerium (III) and cerium (IV) apply for any combinations of soluble and insoluble forms of Ce (III) and soluble and insoluble forms of Ce (IV).

In other rare earth-containing additive formulations, a non-rare earth metal or metalloid is included or added separately to reduce rare earth requirements. Such metals or metalloids include iron (III), aluminum (III), calcium (II), zirconium, and hafnium salts and mixtures thereof. The non-rare-earth metal or metalloid salt can be added before or concurrent with the use of the rare earth-containing additive. Such a mixed additive can be much less expensive than adding the rare earth-containing additives alone. By way of a non-limiting example, certain forms of phosphate (such as phosphate anion) can be removed by the non-rare-earth metal or metalloid while others (such as tripolyphosphates) are not. It can be appreciated that commonly the non-rare earth metal or metalloid may remove certain forms of phosphate to one of a greater, less or about equal extend to the rare earth. The molar ratio of the rare earth metal to the non-rare earth metal or metalloid is commonly no more than about 0.75 moles rare earth:1 mole of non-rare earth metal or metalloid, more commonly no more than about 0.50 moles rare earth:1 mole of non-rare earth metal or metalloid, and even more commonly no more than about 0.25 moles rare earth:1 mole of non-rare earth metal or metalloid. More specifically, non-rare earth metal and/or metalloid can be used to remove some, but not most or all, of deposit material and the rare earth can remove the deposit material not removed by one or both of the non-rare earth metal and/or metalloid.

In some embodiments, contacting a rare earth, in water-soluble and/or water-insoluble forms, and/or the a rare earth-containing additive with a deposit contained in water and/or adhered to a component of a water handling system can remove at least some, if not most, of the deposit from the water and/or the component by forming a deposit-laden rare composition that is one or both of more insoluble and/or more stable than the deposit adhered to the component.

Typically, contacting a rare earth, in a water-soluble and/or water-insoluble form, and/or rare earth-containing additive with a deposit material in the water and/or adhered to a component of the water handling system removes at least about 5 wt. % of the deposit material, more typically at least about 10 wt. % of the deposit material, even more typically at least about 15 wt. % of the deposit material, yet even more typically at least about 20 wt. %, of the deposit material, still yet even more typically at least about 25 wt. % of the deposit material, still yet even more typically at least about 30 wt. % of the deposit material, still yet even more typically at least about 40 wt. % of the deposit material, still yet even more typically at least about 50 wt. % of the deposit material, still yet even more typically at least about 60 wt. % of the deposit material, still yet even more typically at least about 70 wt. % of the deposit material, still yet even more typically at least about 75 wt. % of the deposit material, still yet even more typically at least about 80 wt. % of the deposit material, still yet even more typically at least about 85 wt. % of the deposit material, still yet even more typically at least about 90 wt. % of the deposit material, still yet even more typically at least about 95 wt. % of the deposit material, still yet even more typically at least about 98 wt. % of the deposit material, or still yet even more typically at least about 99 wt. % of the deposit material in the water and/or adhered to a component of the water handling system.

Typically, the deposit suspended in the water can be in the form of particulates having an average deposit particulate size, while the deposit adhered to the component can have an average deposit thickness. While not wanting to be limited by theory, it is believed that contacting the rare earth-containing composition with a solid deposit inhibits increases in the average deposit particulate size and/or deposit thickness. Commonly, contacting the rare earth-containing composition with solid deposit inhibits increases in the average deposit particulate size and/or deposit thickness by at least about 5%, more commonly by at least about 10%, even more commonly by at least about 20%, yet even more commonly by at least about 25%, still yet even more commonly by at least about 30%, still yet even more commonly by at least about 40%, still yet even more commonly by at least about 50%, still yet even more commonly by at least about 60%, still yet even more commonly by at least about 70%, still yet even more commonly by at least about 75%, still yet even more commonly by at least about 80%, still yet even more commonly by at least about 85%, still yet even more commonly by at least about 90%, still yet even more commonly by at least about 95%, still yet even more commonly by at least about 98%, or still yet even more commonly by at least about 99%. The percent inhibitor refers to a comparison of average deposit particulate sizes and/or deposit thicknesses increases overtime a given time period for waters and/or water handling systems without and without a rare earth-containing composition. More specifically,

$$\% inhibition = 100 \times \frac{( increase without rare earth - increase with rare earth )}{increase without rare earth} \qquad 1 )$$

where the term “increase without rare earth” refers to average deposit particulate size and/or deposit thickness increase in the absence of a rare earth-containing composition and the term “increase with rare earth” refers to average deposit particulate size and/or deposit thickness increase after contacting with a rare earth-containing composition.

In accordance with some embodiments, contacting the rare earth-containing composition with the deposit material may inhibit the accumulation of deposit material on a component of the water handling system. Furthermore, the contacting of the rare earth-containing composition with deposit material may one or more of: a) inhibit increases in the suspended deposit material particle size; b) inhibit aggregation, agglomeration or association of the suspended deposit material; c) substantially remove one or more components of the suspended deposit material contained in the water; and d) decrease suspended deposit material particle size.

While not wanting to be bound by theory, it is believed that the rare earth-containing composition chemically interacts with the deposit material. More specifically, the contacting of the rare earth-containing composition with the deposit material can comprise a chemical interaction of the rare earth-containing composition with the deposit material. Even more specifically, the chemical interaction of the rare earth-containing composition with the deposit material forms a deposit-laden material.

The chemical interaction of the rare earth-containing composition with the deposit material is substantially strong enough to remove at least some, if not most or all, of the accumulated deposit material from the water and/or component of the water handling system. The rare earth-containing composition can be any rare earth-containing composition having one or both of +3 and +4 oxidation states. Preferably, the rare earth composition comprises a water-soluble rare composition. More preferably, the water-soluble rare earth composition comprises a rare earth having a +3 oxidation state. The +3 rare earth ion can chemically interact with the deposit material to remove and/or inhibit accumulation of the deposit material within the water and/or water handling system. Preferred +3 rare earth ions are lanthanum (+3), cerium (+3) and praseodymium (+3), neodymium (+3) and samarium (+3) or a combination thereof. More preferred are lanthanum (+3) and cerium (+3). Cerium (+3) substantially in the dissociated, dissolved state is even more preferred.

In some embodiments, the chemical interaction of the rare earth +3 ion with the deposit material is substantially strong enough that some, if not most or all, of the deposit material adhered to the component of the water handling system may be removed from the surface. Preferably, at least some, if not most or all, of the adhered deposit material is removed by a rare earth-containing composition comprising a water-soluble form of one of cerium (+3), lanthanum (+3), praseodymium (+3), neodymium (+3), samarium (+3) and a combination thereof.

For example, it is believed that the chemical interaction of a rare earth ion, specifically a rare earth cation, for an oxyanion is greater than the chemical interaction of the oxyanion with a cation of groups 1, 2, 4, 5, 6, 7, 8, 9, 10, 11, 12, 13, 14 and 15 of the periodic table. More specifically, it is believed that the chemical interaction of a rare earth cation with one of phosphate, carbonate, sulfate, silicate, arsenate or a mixture thereof is greater than the chemical interaction of the oxyanion with one or more of calcium, barium, strontium, ammonium, and magnesium.

In some embodiments, the formation of the deposit-laden composition by the contacting of the rare earth-containing composition with an oxyanion contained in a deposit material on a component within the water handling system one or both of removes the deposit material from the component and inhibits further deposition of the deposit material. Preferably, the deposit material comprises an oxyanion-containing material. Without wanting to be bound by any theory, formation of the deposit-laden composition substantially removes the oxyanions comprising the deposit material from the deposit material, thereby dissolving and/or removing the deposit material from the component the deposit material is adhered to. Regarding inhibition of further deposition of the deposition material, it is believed that formation of the deposit-laden composition layer on the deposit material adhered to the component of the water handling system substantially blocks, that is inhibits, further deposition of the deposit material on the component of the water handling system. The deposit-laden composition can comprise a rare earth and an oxyanion in the form of a rare earth, oxyanion composition (that is, [rare earth]ₓ[oxyanion]_{y} where x and y are positive real numbers). Preferably, the rare earth-containing composition comprises a rare earth cation. The deposit-laden composition layer may be a continuous or discontinuous layer. The deposit-laden composition layer can have a thickness of less than about 1 Å to more than about 100 Å. Preferably the deposit-laden composition and/or deposit-laden composition layer comprise at least one of cerium, lanthanum, praseodymium, neodymium, samarium and a combination thereof. The rare earths comprising the deposit-laden composition and/or deposit-laden composition layer preferably have one of a +3 oxidation state, a +4 oxidation state or a mixture of +3 and +4 oxidation states.

For example, the chemical interaction of a rare earth ion with phosphate (a non-limiting example of an oxyanion) is greater than the chemical interaction of magnesium and ammonium with phosphate. While not wanting to be limited by example, the chemically interaction of a rare earth cation with phosphate is believed to be greater than the chemical interaction of ammonium and magnesium with phosphate within struvite (NH₄MgSO₄). As such, the rare earth ion is able to one or more of substantially remove a struvite deposit, inhibit and/or stop a struvite deposit from forming, inhibit and/or stop a struvite deposit from increasing in thickness, or a combination thereof. The rare earth cation may have a +3 oxidation sate, a +4 oxidation or comprise a mixture of cations having +3 and +4 oxidation sates.

In accordance some embodiments, the formation of the deposit-laden composition by the contacting of the rare earth-containing composition with a deposit material dissolved in water one or both of removes the deposit material from the water, inhibits and/or stops further deposition of the deposit material formation on a component of the water handling system. Furthermore, in some configurations, the formation of the deposit-laden composition substantially removes most of the deposit material dissolved in the water to form a substantially deposit-depleted solution. Moreover, in some configurations, the formation of the deposit-laden composition substantially inhibits and/or stops further deposit formation on components within the water handling system. Preferably, the deposit material comprises an oxyanion-containing material and/or the deposit-laden composition comprises a rare earth and an oxyanion in the form of a rare earth, oxyanion composition.

In accordance with some embodiments, the deposit material is in the form of particulates suspended in the water. The particulates have an average particle size. Furthermore, in some configurations, the formation of the deposit-laden composition by the contacting of the rare earth-containing composition with the particulates one or more of removes the deposit material from the particulates to dissolves the particulates, removes the deposit material from the particulates to decrease the average particle size of the particulates, and forms a deposit-laden composition layer on the particulates to inhibit an increase of the average particulate size of the particulates. Preferably, the particulates comprise an oxyanion-containing material and/or the deposit-laden composition comprises a rare earth and an oxyanion in the form of a rare earth, oxyanion composition. While not wanting to be bound by any theory, formation of the deposit-laden composition substantially removes the oxyanions comprising the particulates from the particulates, thereby dissolving and/or decreasing the average particle size of the particulates. Regarding inhibition of increases in the average particle size, it is believed that formation of the deposit-laden composition layer on the particulate substantially blocks, that is inhibits, further deposition of the deposit material on the particulates to increase the average particle size of the particulates. The deposit-laden composition layer may be a continuous or discontinuous layer. The deposit-laden composition layer can have a thickness of less than about 1 Å to more than about 100 Å. Preferably, the deposit-laden composition and/or deposition composition layer comprise at least one of cerium, lanthanum, praseodymium, neodymium, samarium and a combination thereof. The rare earths comprising the deposit-laden composition and/or the deposit laden composition layer preferably have one of a +3 oxidation state, a +4 oxidation state or a mixture of +3 and +4 oxidation states.

The deposit-laden composition may be in the form of colloid and/or suspension. The deposit-laden composition may be removed from the water and/or water handling system by any solid liquid separation method. Non-limiting examples of suitable solid liquid separation processes are clarification (including thickening) filtration (including vacuum and/or pressure filtering), cyclone (including hydrocyclones), floatation, sedimentation (including gravity sedimentation), coagulation, flocculation and combinations thereof.

The rare earth-containing layer may be a continuous or discontinuous layer. The rare earth-containing layer can have a thickness of less than about 1 Å to more than about 100 Å. Preferably, the rare earth-containing layer comprises at least one of cerium +3, lanthanum +3, praseodymium +3, and a combination thereof.

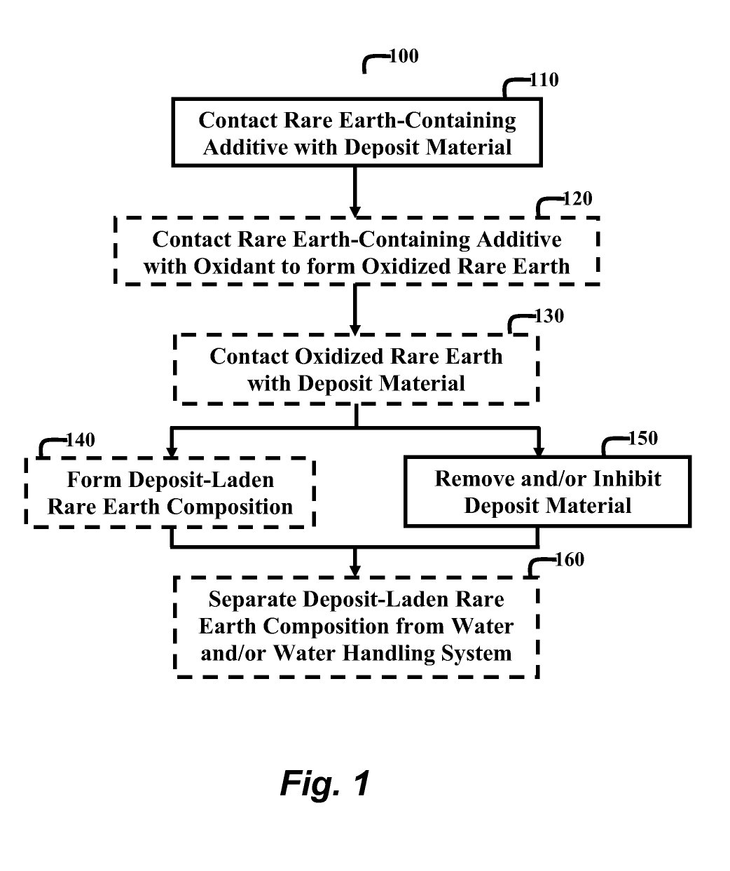

FIG. 1 depicts a process 100 according to an embodiment for removing a deposit material from water and/or a water handling system.

In step 110, a rare earth and/or rare earth-containing additive is contacted with the deposit material. Typically, the deposit material is one or more of a scale adhered to one or more components comprising the water handling system, particulates suspended in the water and/or a form of the deposit material dissolved in the water. The rare earth and/or rare earth-containing additive may comprise one or more of the rare earths, rare earth-containing compositions and/or rare earth-containing additives described in one or embodiments of this disclosure.

In optional step 120, a first rare earth comprising the rare earth and/or rare earth-containing additive and having a first oxidation state is contacted with an oxidant to oxidize the first rare earth to a second oxidation state. It can be appreciated that the second oxidation state of the first rare is greater than the first oxidation state. The oxidant may comprise any of the above-described oxidants. Preferably, the first rare earth comprises cerium. More preferably, the first oxidation state of the first rare earth is a +3 oxidation state and the second oxidation of the first rare earth is a +4 oxidation state. In some embodiments, the first rare earth having the first oxidation state is a water-soluble rare earth and the first rare earth having the second oxidation state comprises a water-insoluble rare earth. Preferably, the first rare earth having the second oxidation state comprises an insoluble rare composition, such as, hut not limited to, a rare earth oxide, rare earth hydroxide, rare earth oxyhydroxy, rare earth hydrous oxide, rare earth hydrous oxyhydroxy, or a mixture thereof. More preferably, the first rare earth having the second oxidation state comprises CeO₂ and Ce(IV)(OH)ₓ(H₂O)_{y}.zH₂O, where x, y and are real numbers, where the hydroxyl and water associated with x and y are intercoordination sphere entities chemically coordinated to the Ce (IV) and the water associated with z represents outersphere waters that are not chemically coordinated with the Ce (IV), that is, the water(s) are not substantially associated with one or more of the s, p, d and/or f-orbitals of the Ce (IV). Typically, x can be from about 0 to about 8, more typically form about 0 to about 4. Commonly y can be from about 0 to about 8, more typically from about 2 to about 4. Typically, z can be from about 0 to about 10, more typically from about 0 to about 6.

In optional step 130, an oxidized rare earth is contacted with the deposit material. The oxidized rare may be a rare earth formed in optional step 120 or a rare earth from step 110. While not wanting to be limited by example, the rare earth and/or rare earth-containing additive of step 110 may comprise rare earths having a mixture of first and second oxidation states, the first oxidation state being lower than the second oxidation state.

In step 130, a deposit-laden rare earth composition may be formed by the contacting of the deposit material with the rare earth and/or rare earth-containing additive in steps 110 and/or 130.

In step 150, the deposit material is removed and/or inhibited from deposition from the water and/or water handling system by the contacting of the deposit material with the rare earth and/or rare earth-containing additive in steps 110 and/or 130.

It can be appreciated that steps 130 and 150 may be preformed substantially concurrently or sequentially in any order. For example, the formation of the deposit-laden material may one or both remove and substantially inhibit the formation of deposit material in the water and/or water handling system.

In optional step 160, the deposit-laden material is separated from the water and/or water handling system by a liquid solid separation process. The liquid water separation process may be one of a clarification (including thickening) filtration (including vacuum and/or pressure filtering), cyclone (including hydrocyclones), floatation, sedimentation (including gravity sedimentation), coagulation, flocculation process and a combination thereof.

### EXAMPLES

### Example A

Struvite particles of comprising NH₄MgPO₄.6H₂O were mixed in CeCl₃ solutions having different molar ratios of CeCl₃ to NH₄MgPO₄.6H₂O of about 0.8, 1.0, 1.2 and 1.5 CeCl₃ to NH₄MgPO₄.6H₂O. In each instance, the mass of the struvite was about 0.2 g, and the concentration of CeCl₃ was about 0.5 mole/L. Furthermore, controls of about 0.2 grams of struvite in about 0.1 L de-ionized water were prepared. The pH value of each solution was adjusted to a pH of about pH 4.3±0.2. Magnetic stir-bars were used to stir each sample solution. After stifling for at least about 16 hours, the solids were filtered from the solution. The filtered solids were analyzed by x-ray diffraction and the solutions were analyzed by ICP-MS. Final solution pH values of the solutions ranged from about pH 4.6 to about pH 8.0. The results are summarized in Table I.

TABLE I

| | Nominal Concentrations | | | | | Residual Concentrations | | | | |
|---|---|---|---|---|---|---|---|---|---|---|
| Sample | Struvite | pH | Mg | P | Ce | pH | Mg | P | Ce | P |
| ID | (mg) | Initial | (ppm) | (ppm) | (ppm) | Final | (ppm) | (ppm) | (ppm) | Removal |
| A | 205 | 5.0 | 203 | 258 | 935 | 8.0 | 140 | 7.9 | <0.1 | 96.9% |
| B | 205 | 5.6 | 203 | 259 | 1171 | 7.9 | 170 | 8.8 | <0.1 | 96.6% |
| C | 199 | 5.6 | 197 | 251 | 1360 | 5.3 | 170 | <0.5 | 62 | >99.8% |
| D | 202 | 4.9 | 200 | 255 | 1732 | 4.7 | 190 | <0.5 | 270 | >99.8% |
| CONTROL | 198 | 5.6 | 196 | 250 | 0 | 9.3 | 19 | 21 | 0 | N/A |
| CONTROL | 204 | 5.0 | 202 | 257 | 0 | 5.1 | 190 | 260 | 0 | N/A |
| CONTROL | 200 | 7.0 | 198 | 253 | 0 | 7.5 | 70 | 100 | 0 | N/A |

### Example B

Struvite, NH₄MgPO₄.6H₂O, particles were mixed in about 0.1 L solutions containing different rare earth chlorides. The rare earth chloride solutions were about 0.15 mol/L solutions of LaCl₃, CeCl₃, PrCl₃ and NdCl₃. The mass of struvite added to each rare earth chloride solution was about 0.2 g and the molar ratio of the rare earth chloride to struvite was about 1.0. The pH of rare earth chloride solution was adjusted to a pH of about pH 4.3±0.2. Magnetic stir-bars were used to stir each sample solution. After stifling for at least about 16 hours, the solids were filtered from the solution. The filtered solids were analyzed by x-ray diffraction and the solutions were analyzed by ICP-MS. Final solution pH values ranged from about pH 4.6 to about pH 8.0. The results are summarized in Table II.

TABLE II

| Rare | Nominal Concentrations | | | | | Residual Concentrations | | | | |
|---|---|---|---|---|---|---|---|---|---|---|
| Earth | Struvite | pH | Mg | P | REE | pH | Mg | P | REE | P |
| Element | (mg) | Initial | (ppm) | (ppm) | (ppm) | Final | (ppm) | (ppm) | (ppm) | Removal |
| La | 202 | 2.3 | 200 | 255 | 1142 | 2.7 | 150 | <0.5 | 200 | >99.8% |
| Ce | 201 | 7.0 | 199 | 254 | 1148 | 5.4 | 110 | <0.5 | 220 | >99.8% |
| Pr | 201 | 3.41 | 199 | 254 | 1156 | 3.8 | 190 | <0.5 | 0.17 | >99.8% |
| Nd | 202 | 2.7 | 200 | 255 | 1188 | 3.3 | 180 | <0.5 | .012 | >99.8% |

### Example C

Example C is a control having about 0.2 g of struvite, NH₄MgPO₄.6H₂O, particles mixed in about 0.1 L of a 0.15 mol/L acidic ferric chloride, FeCl₃, solution. The molar ratio of ferric chloride to struvite was about 1.0 and the initial pH of the solution was about pH 2.5. The initial pH of the control solution was low enough to dissolve the struvite without the presence of ferric chloride. A magnetic stir-bar was used to stir the control solution. After stirring for at least about 16 hours, the solids were filtered from the control solution. The filtered solids were analyzed by x-ray diffraction and the control solution was analyzed by ICP-MS. Final solution pH value was about pH 2.3. The results are summarized in Table III.

TABLE III

| | Nominal Concentrations | | | | | Residual Concentrations | | | | |
|---|---|---|---|---|---|---|---|---|---|---|
| Metal | Struvite | pH | Mg | P | REE | pH | Mg | P | Metal | P |
| Element | (mg) | Initial | (ppm) | (ppm) | (ppm) | Final | (ppm) | (ppm) | (ppm) | Removal |
| Fe | 200 | 2.5 | 198 | 252 | 454 | 2.3 | 190 | 22 | 2.2 | 91.3% |

The Examples A-C show that struvite can be more effectively removed with rare earth-containing compositions than with other removal materials such as ferric chloride.

### Example D

In accordance with some embodiments, organic compounds and/or oxyanion forms of metals, metalloids, and non-metals may be removed from water by a rare earth-containing composition. Experiments were performed to remove organic and contaminants from de-ionized and NSF standardized waters (see Table IV).

TABLE IV

| | |
|---|---|
| Deposit | Removal Capacity (mg/g) |

| Material | DI | NSF |
|---|---|---|
| Antimonate | 10.91 | — |
| Arsenite | 11.78 | 13.12 |
| Arsenate | 0.86 | 7.62 |
| Nitrate | — | 0.00 |
| Phosphate | — | 35.57 |
| Sulfate | — | 46.52 |

### Example E

A series of experiments were performed, the experiments embody the precipitation of arsenic, in the As (V) state, from a highly concentrated waste stream of pH less than pH 2 by the addition of a soluble cerium salt in the Ce (III) state followed by a titration with sodium hydroxide (NaOH) solution to a range of between pH 6 and pH 10.

In a first test, a 400 mL solution containing 33.5 mL of a 0.07125 mol/L solution of NaH₂AsO₄ was stirred in a beaker at room temperature. The pH was adjusted to roughly pH 1.5 by the addition of 4.0 mol/L HNO₃, after which 1.05 g of Ce(NO₃)₃.6H₂O was added. No change in color or any precipitate was observed upon the addition of the cerium (III) salt. NaOH (1.0 mol/L) was added to the stirred solution at a dropwise pace to bring the pH to pH 10.1. The pH was held at pH 10.2±0.2 for a period of 1.5 hours under magnetic stir. After the reaction, the solution was removed from the stir plate and allowed to settle undisturbed for 12 to 18 hours. The supernatant was decanted off and saved for ICP-MS analysis of Ce and As. The solids were filtered through a 0.4 μm cellulose membrane and washed thoroughly with 500 to 800 mL of de-ionized water. The solids were air-dried and analyzed by X-ray diffraction.

In a second test, a simulated waste stream solution was prepared with the following components: As (1,200 ppm), F (650 ppm), Fe (120 ppm), S (80 ppm), Si (50 ppm), Ca (35 ppm), Mg (25 ppm), Zn (10 ppm), and less than 10 ppm of Al, K, and Cu. The pH of the solution was titrated down to pH 0.4 with concentrated HCl (12.1 mol/L), and the solution was heated to 70° C. A solution of CeCl₃ (6.3 mL, 1.194 mol/L) was added to the hot solution, and the pH was slowly increased to pH 7.5 by dropwise addition of NaOH (20 wt. %, 6.2 mol/L). The solution was then allowed to age at 70° C. under magnetic stirring for 1.5 hours, holding pH at pH 7.5±0.2. The solution was then removed from the heat and allowed to settle undisturbed for 12 to 18 hours. The supernatant was decanted off and saved for ICP-MS analysis of Ce and As. The precipitated solids were centrifuged and washed twice before being filtered through a 0.4 μm cellulose membrane and washed thoroughly with 500 to 800 mL of de-ionized water. The solids were air-dried and analyzed by X-ray diffraction.

In a third test, solid powders of the novel Ce—As compound were tested for stability in a low-pH leach test. 0.5 g of the novel Ce—As compound were added to 10 mL of an acetic acid solution with a pH of either pH 2.9 or pH 5.0. The container was sealed and rotated for 18±2 hours at 30±2 revolutions per minute at an ambient temperature in the range of 22±5° C. After the required rotation time, the solution was filtered through a 0.2 micron filter and analyzed by ICP-MS for Ce and As which may have been leached from the solid. Less than 1 ppm of As was detected by ICP-MS.

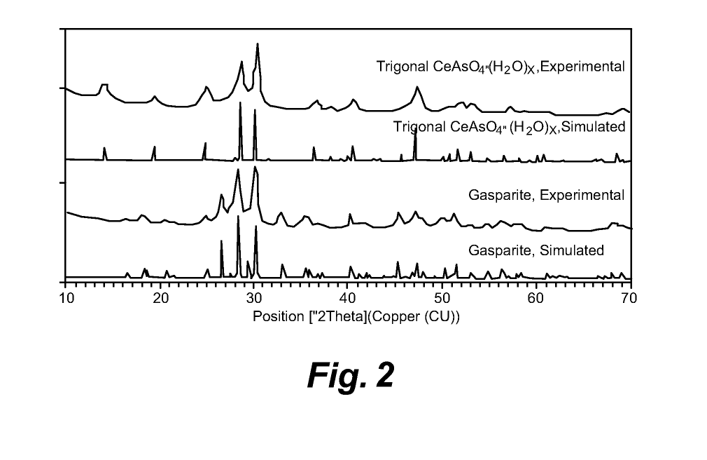

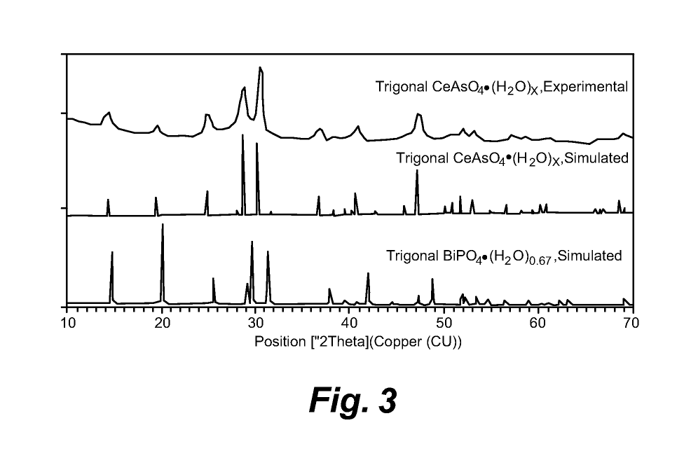

FIG. 2 compares the X-Ray Diffraction (“XRD”) results for the novel Ce—As compound (shown as trigonal CeAsO₄.(H₂O)ₓ (both experimental and simulated) and gasparite (both experimental and simulated). FIG. 3 compares the XRD results for trigonal CeAsO₄.(H₂O)_{X} (both experimental and simulated) and trigonal BiPO₄.(H₂O)_{0.67} (simulated). The XRD results show that the precipitated crystalline compound is structurally different from gasparite (CeAsO₄), which crystallizes in a monoclinic space group with a monazite-type structure, and is quite similar to trigonal BiPO₄.(H₂O)_{0.67}.

Experiments with different oxidation states of Ce and As demonstrate that the novel Ce—As compound requires cerium in the Ce (III) state and arsenic in the As(V) state. pH titration with a strong base, such as sodium hydroxide, seems to be necessary. As pH titration with sodium carbonate produces either gasparite, a known and naturally occurring compound or a combination of gasparite and trigonal CeAsO₄.(H₂O)_{X}. The use of cerium chloride and cerium nitrate both successfully demonstrated the successful synthesis of the novel compound. The presence of other metal species, such as magnesium, aluminum, silicon, calcium, iron, copper, and zinc, have not been shown to inhibit the synthesis of the novel compound. The presence of fluoride will compete with arsenic removal and produce an insoluble CeF₃ precipitate. Solutions containing only arsenic and cerium show that a Ce:As atomic ratio of 1:1 is preferable for forming the novel compound, and solutions containing excess cerium have produced a cerium oxide (CeO₂) precipitate in addition to the novel compound. Additionally, the novel compound appears to be quite stable when challenged with a leach test requiring less than 1 ppm arsenic dissolution in solution of pH 2.9 and pH 5.0.

### Example F

15 ml of CeO₂ obtained from Molycorp, Inc.'s Mountain Pass facility was placed in a ⅞″ inner diameter column.

600 ml of influent containing de-chlorinated water and 3.5×10⁴/ml of MS-2 was flowed through the bed of CeO₂ at flow rates of 6 ml/min, 10 ml/min and 20 ml/min. Serial dilutions and plating were performed within 5 minutes of sampling using the double agar layer method with E. Coli, host and allowed to incubate for 24 hrs at 37° C.

The results of these samples are presented in Table V.

TABLE V

| | Influent | Effluent | Percent | |
|---|---|---|---|---|
| Bed and Flow Rate | Pop./ml | Pop/ml | Reduction | Challenger |
| CeO₂ 6 ml/min | 3.5 × 10⁴ | 1 × 10⁰ | 99.99 | MS-2 |
| CeO₂ 10 ml/min | 3.5 × 10⁴ | 1 × 10⁰ | 99.99 | MS-2 |
| CeO₂ 20 ml/min | 3.5 × 10⁴ | 1 × 10⁰ | 99.99 | MS-2 |

The CeO₂ bed treated with the MS-2 containing solution was upflushed. A solution of about 600 ml of de-chlorinated water and 2.0×10⁶/ml of Klebsiella terrgena was prepared and directed through the column at flow rates of 10 ml/min, 40 ml/min and 80 ml/min. The Klebsiella was quantified using the Idexx Quantitray and allowing incubation for more than 24 hrs. at 37° C.

The results of these samples are presented in Table VI.

TABLE VI

| | Influent | Effluent | Percent | |
|---|---|---|---|---|
| Bed and Flow Rate | Pop./ml | Pop/ml | Reduction | Challenger |
| CeO₂ 10 ml/min | 2.0 × 10⁶ | 1 × 10⁻² | 99.99 | Klebsiella |
| CeO₂ 40 ml/min | 2.0 × 10⁶ | 1 × 10⁻² | 99.99 | Klebsiella |
| CeO₂ 80 ml/min | 2.0 × 10⁶ | 1 × 10⁻² | 99.99 | Klebsiella |

The CeO₂ bed previously challenged with MS-2 and Klebsiella terrgena was then challenged with a second challenge of MS-2 at increased flow rates. A solution of about 1000 ml de-chlorinated water aid 2.2×10⁵/ml of MS-2 was prepared and directed through the bed at flow rates of 80 ml/min, 120 ml/min and 200 ml/min. Serial dilutions and plating were performed within 5 minutes of sampling using the double agar layer method with E. Coli host and allowed to incubate for 24 hrs at 37° C.

The results of these samples are presented in Table VII.

TABLE VII

| | Influent | Effluent | Percent | |
|---|---|---|---|---|
| Bed and Flow Rate | Pop./ml | Pop/ml | Reduction | Challenger |
| CeO₂ 80 ml/min | 2.2 × 10⁵ | 1 × 10⁰ | 99.99 | MS-2 |
| CeO₂ 120 ml/min | 2.2 × 10⁵ | 1.4 × 10² | 99.93 | MS-2 |
| CeO₂ 200 ml/min | 2.2 × 10⁵ | 5.6 × 10⁴ | 74.54 | MS-2 |

### Example G

40.00 g of cerium was added to 1.00 liter of solution containing either 2.02 grams of As(III) or 1.89 grams of As(V). The suspension was shaken periodically, about 5 times over the course of 24 hours. The suspensions were filtered and the concentration of arsenic in the filtrate was measured. For As(III), the arsenic concentration had dropped to 11 ppm. For As(V), the arsenic concentration was still around 1 g/L, so the pH was adjusted by the addition of 3 mL of conc HCl.

Both suspensions were entirely filtered using a vacuum filter with a 0.45 micron track-etched polycarbonate membrane. The final or residual concentration of arsenic in solution was measured by ICP-AES. The solids were retained quantitatively, and resuspended in 250 mL of DI water for about 15 minutes. The rinse suspensions were filtered as before for arsenic analysis and the filtered solids were transferred to a weigh boat and left on the benchtop for 4 hours.

The filtered solids were weighed and divided into eight portions accounting for the calculated moisture such that each sample was expected to contain 5 g of solids and 3.5 g of moisture (and adsorbed salts). One sample of each arsenic laden solid (As(III) or As(V) was weighed out and transferred to a drying oven for 24 hours, then re-weighed to determine the moisture content.

Arsenic-laden ceria samples were weighed out and transferred to 50 mL centrifuge tubes containing extraction solution (Table VIII). The solution (except for H2O2) had a 20-hour contact time, but with only occasional mixing via shaking. Hydrogen peroxide contacted the arsenic-laden solids for two hours and was microwaved to 50 degrees Celsius to accelerate the reaction.

A control sample was prepared wherein the 8.5 g arsenic-laden ceria samples were placed in 45 mL of distilled (DI) water for the same duration as other extraction tests.

The first extraction test used 45 mL of freshly prepared 1 N NaOH. To increase the chances of forcing off arsenic, a 20% NaOH solution was also examined. To investigate competition reactions, 10% oxalic acid, 0.25 M phosphate, and 1 g/L carbonate were used as extracting solutions. To test a reduction pathway 5 g of arsenic-laden ceria was added to 45 mL of 0.1 M ascorbic acid. Alternatively an oxidation pathway was considered using 2 mL 30% H₂O₂ added with 30 mL of DI water

After enough time elapsed for the selected desorption reactions to occur, the samples were each centrifuged and the supernatant solution was removed and filtered using 0.45 micron syringe filters. The filtered solutions were analyzed for arsenic content. Litmus paper was used to get an approximation of pH in the filtered solutions.

Because the reactions based upon redox changes did not show a great deal of arsenic release, the still arsenic-laden solids were rinsed with 15 mL of 1 N NaOH and 10 mL of DI water for 1 hour, then re-centrifuged, filtered, and analyzed.

The results of these desorption experiments can be seen in Table 16. In short, it appears that the desorption of As(III) occurs to a minimal extent. In contrast, As(V) adsorption exhibits an acute sensitivity to pH, meaning that As(V) can be desorbed by raising the pH above a value of 11 or 12. As(V) adsorption is also susceptible to competition for surface sites from other strongly adsorbing anions present at elevated concentrations.

Using hydrogen peroxide, or another oxidant, to convert As(III) to As(V) appeared to be relatively successful, in that a large amount of arsenic was recovered when the pH was raised using NaOH after the treatment with H₂O₂. However, until the NaOH was added, little arsenic desorbed. This indicates that a basic pH level, or basification, can act as an interferer to As (V) removal by ceria.

While ascorbate did cause a dramatic color change in the loaded media, it was unsuccessful in removing either As(III) or As(V) from the surface of ceria. In contrast, oxalate released a detectable amount of adsorbed As(III) and considerably greater amounts of As(V).

Arsenic

Tables VIII-IX show the test parameters and results.

Table VIII: Loading of cerium oxide surface with arsenate and arsenite for the demonstration of arsenic desorbing technologies.

TABLE VIII

| | | C | | E | F | | | | | K | L | M |
|---|---|---|---|---|---|---|---|---|---|---|---|---|
| | B | Mass | | Resid | As- | G | H | I | J | Rinse | Rinse | Final |
| | [As] | CeO2 | D | [As] | loading | Wet | Wet | Dry | % | Vol | [As] | [As] |
| A | (g/L) | (g) | pH | (ppm) | (mg/g) | Mass | mass | (g) | Solids | (mL) | (ppm) | (mg/g) |
| As | 2.02 | 40.0 | 9.5 | 0 | 50.5 | 68 | 7.48 | 4.63 | 61.9 | 250 | 0 | 50.5 |
| (III) | | | | | | | | | | | | |
| As | 1.89 | 40.0 | 5 | 149 | 43.5 | 69 | 8.86 | 5.33 | 60.2 | 250 | 163 | 42.5 |
| (V) | | | | | | | | | | | | |

Table IX: Loading of cerium oxide surface with arsenate and arsenite for the demonstration of arsenic desorbing technologies.

TABLE IX

| | | | Residual | | | |
|---|---|---|---|---|---|---|
| | [As] | | [As] | As-loading | Rinse [As] | Final [As] |
| | (g/L) | pH | (ppm) | (mg/g) | (ppm) | (mg/g) |
| As(III) | 2.02 | 9.5 | 0 | 50.5 | 0 | 50.5 |
| As(V) | 1.89 | 5 | 149 | 43.5 | 163 | 42.5 |

### Example H

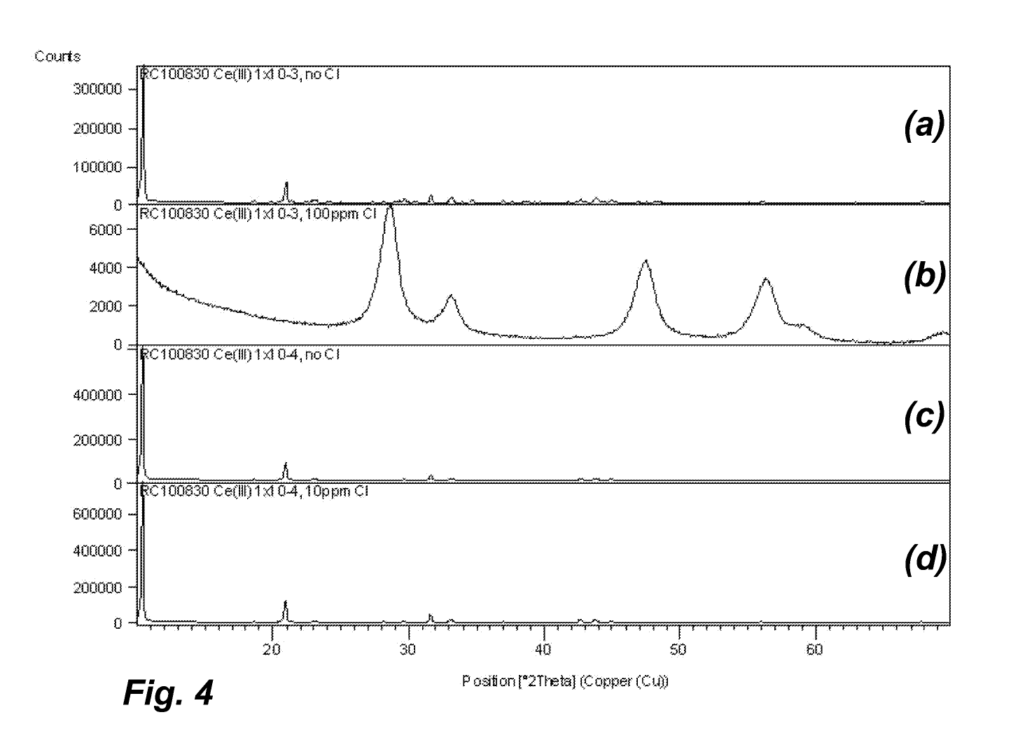

This example is to the formation of insoluble cerium (IV) by the contacting of water-soluble cerium (III) with and oxidizing agent. The oxidizing agent is an aqueous solution containing chlorine. Two aqueous solutions of cerium (III) were prepared from cerium (III) chloride, one solution was about 1×10-3 M and the other aqueous solution was about 1×10-4 M in cerium (III). The 1×10-3 M cerium (III) solution was contacted with an aqueous solution containing 100 ppm chlorine and the 1×10-4 M cerium (III) solution was contacted with an aqueous solution containing 10 ppm chlorine. After each of the cerium (III) solutions with the respective chlorine solutions, the solutions were filtered and the filtrate was subject to an x-ray diffraction analysis. FIG. 4 (a)-(c) depict the x-ray diffraction analysis before and after contacting the cerium (III) containing solutions with the aqueous solutions containing chlorine. FIG. 4 (b) is the x-ray diffraction pattern indicative of cerium (IV) oxide, CeO2. That is, the x-ray diffraction pattern contained peaks at about 28, 32.5, 47 and 56 Cu-2-theta. In other words, the 100 ppm chlorine solution substantially oxidized the cerium (III) contained in the 1×10-3 M cerium (III) solution to produce substantially enough cerium (IV) to obtain an x-ray diffraction of the formed cerium (IV), that is an x-ray diffraction pattern indicative of CeO2. Similarly the 1×10-3 M and 1×10-4 M cerium (III), prior to contacting with the chlorine solutions, were filtered and the resulting filtrates were analyzed by x-ray diffraction analysis, see FIGS. 4 (a) and (d), neither cerium (III) solution contained detectable amounts of cerium (IV). FIG. 4 (d) depicts the x-ray diffraction analysis of filtrate obtained from the 1×10-4 M cerium (III) solution after being contacted with 10 ppm chlorine solution. The x-ray diffraction pattern lacks peaks at about 28, 32.5, 47 and 56 Cu-2-theta. In other words, either cerium (IV) oxide was not formed or the amount of cerium (IV) oxide formed is less than or about equal to the signal-to-noise level in the x-ray diffraction analysis. That is, the amount of cerium (IV) formed is below the detection limit of the x-ray diffraction analysis procedure. Similarly, aeration of 1×10-3 M and 1×10-4 M cerium (III) solutions (that is bubbling air through the solutions) did not produce detectable amounts of cerium (IV) oxide.

A number of variations and modifications of the disclosure can be used. One of more embodiments can of the disclosure can used separately and in combination. That is, any embodiment alone can be used and all combinations and permutations thereof can be used. It would be possible to provide for some features of the disclosure without providing others.

The present disclosure, in various embodiments, configurations, or aspects, includes components, methods, processes, systems and/or apparatus substantially as depicted and described herein, including various embodiments, configurations, aspects, sub-combinations, and subsets thereof. Those of skill in the art will understand how to make and use the various embodiments, configurations, or aspects after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that any claim and/or combination of claims require more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment.

Moreover, though the description of the disclosure has included descriptions of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A process, comprising:
contacting a rare earth-containing additive with a deposit material contained within a water handling system to one or both of remove the deposit material and inhibit deposition of the deposit material.

2. The process of claim 1, wherein the deposit material is adhered to a component of the water handling system.

3. The process of claim 2, wherein the contacting removes at least some of the deposit material adhered to the surface.

4. The process of claim 1, wherein the deposit material comprises struvite.

5. The process of claim 4, wherein at least some of the struvite is removed from the water handling system.

6. The process of claim 1, wherein the deposit material comprises deposit particulates suspended in water.

7. The process of claim 6, wherein the deposit particulates have an average particle size.

8. The process of claim 7, wherein at least some of the deposit particulates are removed from the water handling system.

9. The process of claim 7, wherein the contacting of the rare earth-containing additive with the deposit material substantially inhibits an increase in the average particle size.

10. The process of claim 1, wherein the rare earth-containing additive comprises a water-soluble rare earth-containing composition.

11. The process of claim 10, wherein the water-soluble rare earth-containing composition comprises one of a rare earth having a +3 oxidation state, a +4 oxidation or mixture of +3 and +4 oxidation states.

12. The process of claim 10, wherein the water-soluble rare earth-containing composition comprises a rare earth having a +3 oxidation state.

13. The process of claim 10, wherein the water-soluble rare earth-containing composition comprises cerium.

14. The process of claim 1, wherein the contacting occurs in a water handling system, wherein the contacting of the rare earth-containing additive with the deposit material forms a deposit-laden rare earth composition, further comprising:
removing the deposit laden rare earth composition from the water handling system.

15. The process of claim 14, wherein the deposit-laden rare earth composition is substantially insoluble in water.

16. A process, comprising:
contacting, within a water handling system, a rare earth-containing additive with a deposit material to form a deposit-laden rare composition and to one or both of remove the deposit from the water handling system and inhibit the formation of more deposit material within the water handling system.

17. The process of claim 16, wherein the deposit material is adhered to a component of the water handling system.

18. The process of claim 17, wherein the contacting removes at least some of the deposit material adhered to the component.

19. The process of claim 16, wherein the deposit material comprises struvite, wherein the deposit-laden rare earth material comprises phosphate.

20. The process of claim 19, wherein the struvite is adhered to a component of the water handling system, wherein the contacting of the rare earth-containing additive with the deposit material removes at least some of the struvite.

21. The process of claim 16, wherein the deposit material comprises deposit particulates suspended in water.

22. The process of claim 21, wherein the deposit particulates have an average particle size.

23. The process of claim 22, wherein the contacting of the rare earth-containing additive with the deposit material removes at least some of the deposit particulates from the water handling system.

24. The process of claim 22, wherein the contacting of the rare earth-containing additive with the deposit material substantially inhibits an increase in the average particle size.

25. The process of claim 16, wherein the rare earth-containing additive comprises a water-soluble rare earth-containing composition.

26. The process of claim 25, wherein the water-soluble rare earth-containing composition comprises one of a rare earth having a +3 oxidation state, a +4 oxidation or mixture of +3 and +4 oxidation states.

27. The process of claim 25, wherein the water-soluble rare earth-containing composition comprises a rare earth having a +3 oxidation state.

28. The process of claim 25, wherein the water-soluble rare earth-containing composition comprises cerium.

29. The process of claim 16, further comprising:
removing the deposit laden rare earth composition from the water handling system.

30. The process of claim 16, wherein the deposit-laden rare earth composition is substantially insoluble in water.

31. A process, comprising:
contacting a water handling system containing struvite with a rare earth-containing additive to form a rare earth composition comprising a component of the struvite and to one or both of remove the struvite from the water handling system and inhibit the formation of more struvite within the water handling system.

32. The process of claim 31, wherein the struvite is adhered to a component of the water handling system.

33. The process of claim 32, wherein the contacting removes at least some of the struvite adhered to a component of the water handling system.

34. The process of claim 31, wherein the component of the struvite is phosphate.

35. The process of claim 31, wherein the struvite is in the form of particulates suspended in the water.

36. The process of claim 35, wherein the struvite particulates have an average particle size.

37. The process of claim 36, wherein at least some of the struvite particulates are removed from the water handling system.

38. The process of claim 36, wherein the contacting substantially inhibits an increase in the average particle size.

39. The process of claim 31, wherein the rare earth-containing additive is a water-soluble rare earth-containing composition.

40. The process of claim 39, wherein the water-soluble rare earth-containing composition comprises a rare earth having a +3 oxidation state, a +4 oxidation or mixture of +3 and +4 oxidation states.

41. The process of claim 39, wherein the water-soluble rare earth-containing composition comprises a rare earth having a +3 oxidation state.

42. The process of claim 39, wherein the water-soluble rare earth-containing composition comprises cerium.

43. The process of claim 31, further comprising:
removing the rare earth composition comprising the component of struvite from the water handling system.

44. The process of claim 31, wherein the rare earth composition comprising the component of struvite is substantially insoluble in water.

45. A system, comprising:
a) a deposit-laden water handling system containing a deposit material adhered to a component of the water handling system;
b) an input to receive a rare earth-containing additive, wherein the rare earth-containing additive is contacted with the deposit material to form a deposit-laden rare earth composition and to substantially remove the deposit material adhered to the component of the water handling system; and
c) an output to output the deposit-laden rare earth composition and to form a deposit-free water handling system substantially lacking deposit material adhered to the water handling system.
